(19) United States
(12) Patent Application Publication
(10) Pub. No.: US 2025/0113353 A1
(43) Pub. Date: Apr. 3, 2025

(54) METHOD AND APPARATUS FOR TRANSMISSION AND RECEPTION OF DATA IN WIRELESS COMMUNICATION SYSTEM

(71) Applicant: Samsung Electronics Co., Ltd., Suwon-si (KR)

(72) Inventors: Sungjin PARK, Suwon-si (KR); Hyunsuk RYU, Suwon-si (KR)

(21) Appl. No.: 18/896,077

(22) Filed: Sep. 25, 2024

(30) Foreign Application Priority Data
Sep. 26, 2023 (KR) 10-2023-0129331
Oct. 20, 2023 (KR) 10-2023-0141107

(51) Int. Cl. H04W 72/1268; H04L 1/1812; H04W 72/0446

(52) U.S. Cl. CPC H04W 72/1268; H04L 1/1812; H04W 72/0446

(57) ABSTRACT

The disclosure relates to a fifth generation (5G) or sixth generation (6G) communication system for supporting a higher data transmission rate. A method performed by a user equipment (UE) in a wireless communication system is provided. The method includes transmitting, to a base station (BS), UE capability information for simultaneous transmission of a physical uplink shared channel (PUSCH) and a physical uplink control channel (PUCCH) of a same priority, receiving, from the BS, configuration information for the simultaneous transmission, and transmitting, to the BS, the PUSCH on a first cell and the PUCCH on a second cell based on the configuration information, wherein the PUSCH is excluded from resolving of time overlapping between the PUCCH and the PUSCH based on the configuration information.

### CROSS-REFERENCE TO RELATED APPLICATION(S)

This application is based on and claims priority under 35 U.S.C. § 119(a) of a Korean patent application number 10-2023-0129331, filed on Sep. 26, 2023, in the Korean Intellectual Property Office, and of a Korean patent application number 10-2023-0141107, filed on Oct. 20, 2023, in the Korean Intellectual Property Office, the disclosure of each of which is incorporated by reference herein in its entirety.

### BACKGROUND

### 1. Field

The disclosure relates to the operation of a user equipment (UE) and a base station in a wireless communication system. More particularly, the disclosure relates to a method of configuring/reporting uplink control information in a wireless communication system and an apparatus capable of performing the same.

### 2. Description of Related Art

Fifth generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter-wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively providing services in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes transmitting, to a base station (BS), UE capability information for simultaneous transmission of a physical uplink shared channel (PUSCH) and a physical uplink control channel (PUCCH) of a same priority, receiving, from the BS, configuration information for the simultaneous transmission, and transmitting, to the BS, the PUSCH on a first cell and the PUCCH on a second cell based on the configuration information, wherein the PUSCH is excluded from resolving of time overlapping between the PUCCH and the PUSCH based on the configuration information.

In accordance with another aspect of the disclosure, a method performed by a base station (BS) in a wireless communication system is provided. The method includes receiving, from a user equipment (UE), UE capability information for simultaneous transmission of a physical uplink shared channel (PUSCH) and a physical uplink control channel (PUCCH) of a same priority, transmitting, to the UE, configuration information for the simultaneous transmission, and receiving, from the UE, the PUSCH on a first cell and the PUCCH on a second cell based on the configuration information, wherein the PUSCH is excluded from resolving of time overlapping between the PUCCH and the PUSCH based on the configuration information.

In accordance with another aspect of the disclosure, a user equipment (UE) in a wireless communication system is provided. The UE includes a transceiver, and a controller coupled with the transceiver and configured to transmit, to a base station (BS), UE capability information for simultaneous transmission of a physical uplink shared channel (PUSCH) and a physical uplink control channel (PUCCH) of a same priority, receive, from the BS, configuration information for the simultaneous transmission, and transmit, to the BS, the PUSCH on a first cell and the PUCCH on a second cell based on the configuration information, wherein the PUSCH is excluded from resolving of time overlapping between the PUCCH and the PUSCH based on the configuration information.

In accordance with another aspect of the disclosure, a base station (BS) in a wireless communication system is provided. The BS includes a transceiver, and a controller coupled with the transceiver and configured to receive, from a user equipment (UE), UE capability information for simultaneous transmission of a physical uplink shared channel (PUSCH) and a physical uplink control channel (PUCCH) of a same priority, transmit, to the UE, configuration information for the simultaneous transmission, and receive, from the UE, the PUSCH on a first cell and the PUCCH on a second cell based on the configuration information, wherein the PUSCH is excluded from resolving of time overlapping between the PUCCH and the PUSCH based on the configuration information.

The disclosed embodiments provide an apparatus and a method for effectively providing services in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates physical uplink shared channel (PUSCH) repeated transmission type B in a wireless communication system according to an embodiment of the disclosure;

FIG. 4 illustrates an aperiodic channel state information (CSI) reporting method according to an embodiment of the disclosure;

FIG. 5 illustrates an uplink control information being mapped to a PUSCH according to an embodiment of the disclosure;

FIG. 6 illustrates a procedure of processing transmission and reception uplink control information (UCI) information to and from a PUSCH, the UCI information existing between a UE and a base station, according to an embodiment of the disclosure;

FIG. 7 illustrates a method of configuring a semi-static hybrid automatic repeat request-acknowledgment (HARQ-ACK) codebook (or Type-1 HARQ-ACK codebook) in an NR system according to an embodiment of the disclosure;

FIG. 8 illustrates a method of configuring a dynamic HARQ-ACK codebook (or Type-2 HARQ-ACK codebook) in an NR system according to an embodiment of the disclosure;

FIG. 9 illustrates a situation in which a plurality of different HARQ-ACK codebooks are overlapped according to an embodiment of the disclosure;

FIG. 10 is a block diagram illustrating a physical uplink control channel (PUCCH) or PUSCH transmission operation of a UE according to an embodiment of the disclosure;

FIG. 11 illustrates a relationship between a semi-persistent scheduling (SPS) physical downlink shared channel (PDSCH) and transmission of HARQ-ACK information thereto according to an embodiment of the disclosure;

FIG. 12 illustrates a relationship of HARQ-ACK information transmission with respect to PDSCH reception in a carrier aggregation (CA) situation according to an embodiment of the disclosure;

FIG. 13 illustrates a relationship of HARQ-ACK information transmission with respect to PDSCH reception in a CA situation according to an embodiment of the disclosure;

FIG. 14 is a flow diagram illustrating a base station operation based on UE capability of supporting 4-bit PDSCH-to-HARQ_feedback timing according to an embodiment of the disclosure;

FIG. 15 is a flow diagram illustrating a UE operation based on UE capability of supporting 4-bit PDSCH-to-HARQ_feedback timing according to an embodiment of the disclosure;

FIG. 16 is a flow diagram illustrating a base station operation based on a UE capability of supporting simultaneous PUCCH and PUSCH transmission according to an embodiment of the disclosure;

FIG. 17 is a flow diagram illustrating a UE operation based on UE capability of supporting simultaneous PUCCH and PUSCH transmission according to an embodiment of the disclosure;

FIG. 18 illustrates a structure of a UE in a wireless communication system according to an embodiment of the disclosure; and

FIG. 19 illustrates a structure of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

To meet the demand for wireless data traffic having increased since deployment of fourth generation (4G) communication systems, efforts have been made to develop an improved 5G or pre-5G communication system. Therefore, the 5G or pre-5G communication system is also called a “beyond 4G network” communication system or a “post long term evolution (LTE)” system. The 5G communication system is considered to be implemented in ultrahigh frequency (mmWave) bands, (e.g., 60 GHz bands) so as to accomplish higher data rates. To decrease the propagation loss of the radio waves and increase the transmission distance of radio waves in the ultrahigh frequency (mmWave) bands, beamforming, massive multiple-input multiple-output (massive MIMO), full dimensional MIMO (FD-MIMO), array antenna, an analog beam forming, and large scale antenna techniques have been discussed in the 5G communication system. In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like. In the 5G system, hybrid frequency shift keying (FSK) and quadrature amplitude modulation (QAM) modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, or the like, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems (5th generation communication system or new radio (NR)) to IoT networks. For example, technologies, such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

With the advance of wireless communication systems as described above, various services can be provided, and accordingly there is a need for ways to smoothly provide these services.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The terms which will be described below are terms defined in based on the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3^{rd} generation partnership project (3GPP), LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multiple-input multiple-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years because it is difficult to frequently replace the battery of the UE.

Lastly, URLLC is a cellular-based mission-critical wireless communication service. For example, URLLC may be used for services, such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

Hereinafter, embodiments of the disclosure will be described in conjunction with the accompanying drawings. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, 5G systems will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to frequency division duplex (FDD) and time division duplex (TDD) systems.

Furthermore, in describing the disclosure, a detailed description of known functions or configurations incorporated herein will be omitted when it is determined that the description may make the subject matter of the disclosure unnecessarily unclear. The terms which will be described below are terms defined in based on the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU)(e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

### [NR Time-Frequency Resources]

Hereinafter, a frame structure of a 5G system will be described with reference to the accompanying drawings.

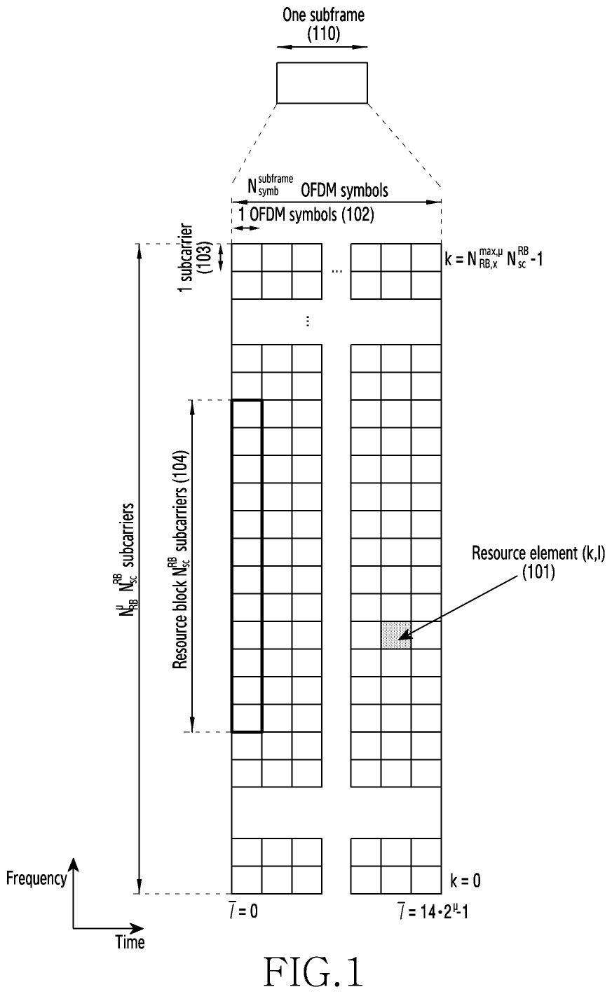

FIG. 1 illustrates a basic structure of a time-frequency domain in a wireless communication system according to an embodiment of the disclosure. FIG. 1 illustrates a basic structure of a time-frequency domain, which is a radio resource domain used to transmit data or control channels, in a 5G system.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104. FIG. 1 illustrates the structure for one subframe 110.

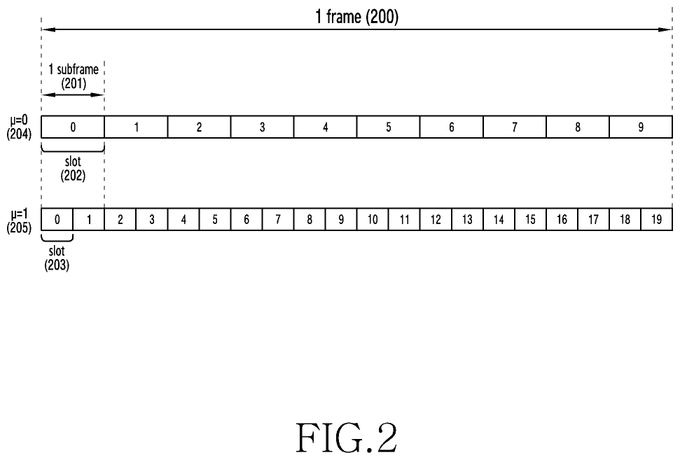

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values p for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. For example, the number of slots per one subframe Nₛₗₒₜ^{subframe,μ} may differ depending on the subcarrier spacing configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [PDCCH: Regarding DCI]

Next, downlink control information (DCI) in a 5G system will be described below.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. For example, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information, for example.

TABLE 2
- Identifier for DCI formats - [1] bit
- Frequency domain resource assignment -
[┌log₂(N_{RB}^{UL,BWP}(N_{RB}^{UL,BWP} +1)/2)┐ ] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2]
bits
- Uplink/ supplementary uplink (UL/SUL) indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information, for example.

TABLE 3
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
For resource allocation type 0, ┌N_{RB}^{UL,BWP}/P┐ bits
For resource allocation type 1, ┌log₂( N_{RB}^{UL,BWP}(N_{RB}^{UL,BWP} + 1)/2)┐ bits
- Time domain resource assignment - 1, 2, 3, or 4 bits
- Virtual resource block (VRB)-to-physical resource block (PRB)
mapping - 0 or 1 bit, only for resource allocation type 1.
0 bit if only resource allocation type 0 is configured;
1 bit otherwise.
- Frequency hopping flag - 0 or 1 bit, only for resource allocation type 1.
0 bit if only resource allocation type 0 is configured;
1 bit otherwise.
- Modulation and coding scheme - 5 bits
- New data indicator - 1 bit
- Redundancy version - 2 bits
- HARQ process number - 4 bits
- 1st downlink assignment index- 1 or 2 bits
1 bit for semi-static HARQ-ACK codebook;
2 bits for dynamic HARQ-ACK codebook with single HARQ-ACK codebook.
- 2nd downlink assignment index - 0 or 2 bits
2 bits for dynamic HARQ-ACK codebook with two HARQ-ACK sub-codebooks;
0 bit otherwise.
- TPC command for scheduled PUSCH - 2 bits
$SRS rescource indicator ‐ ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits * ⌈ {log}_{2} ( {\sum }_{k = 1}^{{L}_{max}} ( \begin{matrix}{N}_{SRS} \\ k\end{matrix} ) ) ⌉$
bits for non-codebook based PUSCH transmission;
┌log₂(N_{SRS})┐ bits for codebook based PUSCH transmission.
- Precoding information and number of layers - up to 6 bits
- Antenna ports - up to 5 bits
- SRS request - 2 bits
- Channel state information (CSI) request - 0, 1, 2, 3, 4, 5, or 6 bits
- Code block group (CBG) transmission information - 0, 2, 4, 6, or 8 bits
- Phase tracking reference signal (PTRS)-demodulation reference signal
(DDMRS) association - 0 or 2 bits.
- beta_offset indicator - 0 or 2 bits
- DMRS sequence initialization - 0 or 1 bit

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information, for example.

TABLE 4
- Identifier for DCI formats - [1] bit
- Frequency domain resource assignment -
[┌log₂(N_{RB}^{DL,BWP}(N_{RB}^{DL,BWP} +1)/2)┐ ] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Pysical uplink control channel (PUCCH) resource indicator - 3 bits
- PDSCH-to-HARQ feedback timing indicator - [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information, for example.

TABLE 5
- Carrier indicator - 0 or 3 bits
- Identifier for DCI formats - [1] bits
- Bandwidth part indicator - 0, 1 or 2 bits
- Frequency domain resource assignment
* For resource allocation type 0, ┌N_{RB}^{DL,BWP}/P┐ bits
* For resource allocation type 1, ┌log₂(N_{RB}^{DL,BWP}(N_{RB}^{DL,BWP} +1)/2)┐ bits
- Time domain resource assignment -1, 2, 3, or 4 bits
- VRB-to-PRB mapping - 0 or 1 bit, only for resource allocation type 1.
* 0 bit if only resource allocation type 0 is configured;
* 1 bit otherwise.
- Physical resource block (PRB) bundling size indicator - 0 or 1 bit
- Rate matching indicator - 0, 1, or 2 bits
- Zero power (ZP) channel state information (CSI)-reference signal (RS)
trigger - 0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- CBG flushing out information - 0 or 1 bit
- DMRS sequence initialization - 1 bit

### [PDSCH: Processing Time]

Next, a PDSCH processing time (PDSCH processing procedure time) will be described. If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH processing time of the UE may follow Equation 1 given below.

$${T}_{proc , 1} = ( {N}_{1} + {d}_{1 , 1} + {d}_{2} ) ( 2048 + 1 \; 44 ) κ {2}^{- μ} {T}_{c} + {T}_{ext} \qquad Equation 1$$

Each parameter in T_{proc,1} described above in Equation 1 may have the following meaning.
N₁: the number of symbols determined according to UE processing capability 1 or 2 based on the UE's capability and numerology μ. N₁ may have a value in Table 6 if UE processing capability 1 is reported according to the UE's capability report. N₁ may have a value in Table 7 if UE processing capability 2 is reported, and if availability of UE processing capability 2 is configured through upper layer signaling. The numerology μ may correspond to the minimum value among μ_{PDCCH}, μ_{PDSC}, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted. Table 6 shows the PDSCH processing time in the case of PDSCH processing capability 1. Table 7 shows the PDSCH processing time in the case of PDSCH processing capability 2.

TABLE 6

PDSCH decoding time N₁ [symbols]

| | | If PDSCH mapping type A |
|---|---|---|
| | | and B both do not correspond |
| | If PDSCH mapping type A | to dmrs-AdditionalPosition = |
| | and B both correspond to | pos0 inside DMRS- |
| | dmrs-AdditionalPosition = | DownlinkConfig which is |
| | pos0 inside DMRS- | upper layer signaling, or |
| | DownlinkConfig which is | if no upper layer parameter |
| μ | upper layer signaling | is configured |
| 0 | 8 | N_{1, 0} |
| 1 | 10 | 13 |
| 2 | 17 | 20 |
| 3 | 20 | 24 |

TABLE 7

| | PDSCH decoding time N₁ [symbols] |
|---|---|
| | If PDSCH mapping type A and B both correspond to dmrs- |
| | AdditionalPosition = pos0 inside DMRS-DownlinkConfig |
| μ | which is upper layer signaling |
| 0 | 3 |
| 1 | 4.5 |
| 2 | 9 for frequency range 1 |

κ: 64
Tₑₓₜ: if the UE uses a shared spectrum channel access scheme, the UE may calculate Tₑₓₜ and apply the same to the PDSCH processing time. Otherwise, Tₑₓₜ is assumed to be 0.
If 1₁ which represents the PDSCH DMRS location value is 12, N_{1,0} in Table 22 above has the value of 14, and otherwise has the value of 13.
With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.
If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If −L≥4 and L≤6, then d_{1,1}=7−L.
If L=3, then d_{1,1}=min (d, 1).
If L=2, then d_{1,1}=3+d.
If PDSCH mapping type B is used with regard to UE processing capability 2, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If −L≥4 and L≤6, then d_{1,1}=7−L.
If L=2,
If the scheduling PDCCH exists inside a CORESET including three symbols, and if the CORESET and the scheduled PDSCH have the same start symbol, then d_{1,1}=3.
Otherwise, d_{1,1}=d.
In the case of a UE supporting capability 2 inside a given serving cell, the PDSCH processing time based on UE processing capability 2 may be applied by the UE if processingType2Enabled (upper layer signaling) is configured as “enable” with regard to the corresponding cell.

If the location of the first uplink transmission symbol of a PUCCH including HARQ-ACK information (in connection with the corresponding location, K¹ defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of T_{proc,1}, the UE needs to transmit a valid HARQ-ACK message. For example, the UE needs to transmit a PUCCH including a HARQ-ACK only if the PDSCH processing time is sufficient. The UE cannot otherwise provide the base station with valid HARQ-ACK information corresponding to the scheduled PDSCH. The T-_{proc,1} may be used in the case of either a normal or an expanded CP. In the case of a PDSCH having two PDSCH transmission locations configured inside one slot, d_{1,1} is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception reparation time (N_{pdsch}) of the UE defined with regard to the time interval between the PDCCH and PDSCH will be described.

If μ_{PDCCH}<μPDSCH, the scheduled PDSCH cannot be transmitted before the first symbol of the slot coming after N_{pdch} symbols from the last symbol of the PDCCH that scheduled the corresponding PDSCH.

The transmission symbol of the corresponding PDSCH may include a DM-RS.

If μ_{PDCCH}<μ_{PDSCH}, the scheduled PDSCH cannot be transmitted before the first symbol of the slot coming after N_{pdch} symbols from the last symbol of the PDCCH that scheduled the corresponding PDSCH. The transmission symbol of the corresponding PDSCH may include a DM-RS. Table 8 shows N_{pdch} according to scheduled PDCCH subcarrier spacing.

TABLE 8

| | N_{pdsch} |
|---|---|
| μ_{PDCCH} | [symbols] |
| 0 | 4 |
| 1 | 5 |
| 2 | 10 |
| 3 | 14 |

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 9 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 9 through upper signaling. If PUSCH transmission is operated by a configured grant, parameters applied to the PUSCH transmission are applied through configuredGrantConfig (upper signaling) in Table 9 except for dataScramblingIdentityPUSCH, txConfig, codebookSubset, maxRank, and scaling of UCI-OnPUSCH, which are provided by pusch-Config (upper signaling) in Table 10. If provided with transformPrecoder inside configuredGrantConfig (upper signaling) in Table 9, the UE applies tp-pi2BPSK inside pusch-Config in Table 10 to PUSCH transmission operated by a configured grant.

TABLE 9

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |

| | |
|---|---|
| srs-ResourceIndicator | INTEGER (0..15) |

OPTIONAL, -- Need R

| | |
|---|---|
| mcsAndTBS | INTEGER (0..31), |

| | |
|---|---|
| frequencyHoppingOffset | INTEGER (1.. |

| | |
|---|---|
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for sounding reference signal (SRS) transmission. PUSCH transmission may follow a codebook-based transmission method and a non-codebook-based transmission method according to whether the value of txConfig inside pusch-Config in Table 10, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 10, the UE does not expect scheduling through DCI format 0_1.

TABLE 10

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |

| | |
|---|---|
| UplinkConfig } | OPTIONAL, -- Need M |

| | |
|---|---|
| dmrs-UplinkForPUSCH-MappingTypeB | SetupRelease { DMRS- |

| | |
|---|---|
| UplinkConfig } | OPTIONAL, -- Need M |

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER |

(1.. maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent, nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected non-zero power CSI-RS (NZP CSI-RS resource) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 2 given below.

$${T}_{proc , 2} = max ( ( {N}_{2} + {d}_{2 , 1} + {d}_{2} ) ( 2048 + 1 \; 44 ) κ {2}^{- μ} {T}_{c} + {T}_{ext} + {T}_{switch} , {d}_{2 , 2} ) \qquad Equation 2$$

Each parameter in T_{proc,2} described above in Equation 2 may have the following meaning.
N₂: the number of symbols determined according to UE processing capability 1 or 2, based on the UE's capability, and numerology μ. N₂ may have a value in Table 40 if UE processing capability 1 is reported according to the UE's capability report, and may have a value in Table 41 if UE processing capability 2 is reported, and if availability of UE processing capability 2 is configured through upper layer signaling.

TABLE 11

| | PUSCH preparation |
|---|---|
| μ | time N₂ [symbols] |
| 0 | 10 |
| 1 | 12 |
| 2 | 23 |
| 3 | 36 |

TABLE 12

| | PUSCH preparation |
|---|---|
| μ | time N₂ [symbols] |
| 0 | 5 |
| 1 | 5.5 |
| 2 | 11 for frequency |
| | range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.

T_{c}: has 1/(Δfₘₐₓ·N_{f}), Δfₘₐₓ=480·10³ Hz, N_{f}=4096.
d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repeated Transmission]

Hereinafter, repeated transmission of an uplink data channel in a 5G system will be described below. A 5G system supports two types of methods for repeatedly transmitting an uplink data channel, PUSCH repeated transmission type A and PUSCH repeated transmission type B. One of PUSCH repeated transmission type A and type B may be configured for a UE through upper layer signaling.

PUSCH repeated transmission type A
As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).
Based on the number of repeated transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repeated transmissions of the uplink data channel.

PUSCH repeated transmission type B
As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by mod(S+n·L, N_{symb}^{slot}). The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod(S+(n+1)·L−1, N_{symb}^{slot}). In this regard, n=0, . . . , numberofrepetitions-1, S refers to the start symbol of the configured uplink data channel, and L refers to the symbol length of the configured uplink data channel. Kₛ refers to the slot in which PUSCH transmission starts, and N_{symb}^{slot} refers to the number of symbols per slot.
The UE determines an invalid symbol for PUSCH repeated transmission type B. A symbol configured as a downlink by tdd-UL-DL-ConfigurationCommon or tdd-UL-DL-ConfigurationDedicated is determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 represents the invalid symbol. Additionally, the cycle and pattern of the bitmap may be configured through the upper layer parameter (for example, InvalidSymbolPattem). If an upper layer parameter (for example, InvalidSymbolPattem) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

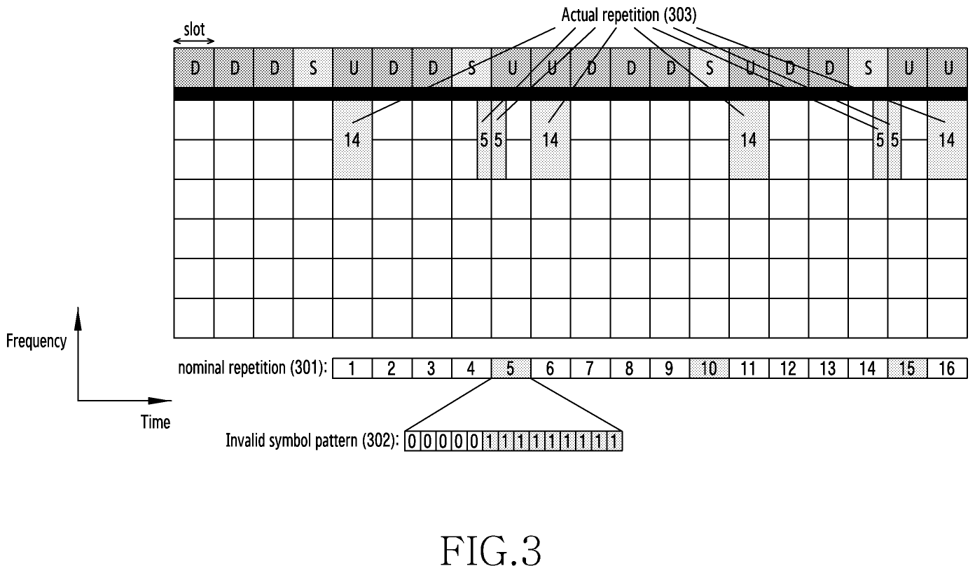

FIG. 3 illustrates PUSCH repeated transmission type B in a wireless communication system according to an embodiment of the disclosure.

Referring to FIG. 3, the UE may receive the following configurations: the start symbol S of an uplink data channel is 0, the length L of the uplink data channel is 14, and the number of repeated transmissions is 16. In this case, nominal repetitions may appear in 16 consecutive slots (301). Thereafter, the UE may determine that the symbol configured as a downlink symbol in each nominal repetition 301 is an invalid symbol. The UE determines that symbols configured as 1 in the invalid symbol pattern 302 are invalid symbols. If valid symbols other than invalid symbols in respective nominal repetitions 301 constitute one or more consecutive symbols in one slot, they are configured and transmitted as actual repetitions 303.

In addition, with regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repeated transmissions are scheduled inside one slot or across the boundary of consecutive slots. In connection with method 1, time domain resource allocation information inside DCI indicates resources of the first repeated transmission. In addition, time domain resource information of remaining repeated transmissions may be determined according to time domain resource information of the first repeated transmission, and the uplink or downlink direction determined with regard to each symbol of each slot. Each repeated transmission occupies consecutive symbols.
Method 2 (multi-segment transmission): through one UL grant, two or more PUSCH repeated transmissions are scheduled in consecutive slots. Transmission no. 1 may be designated with regard to each slot, and the start point or repetition length may differ between respective transmission. method 2, time domain resource allocation information inside DCI indicates the start point and repetition length of all repeated transmissions. In the case of performing repeated transmissions inside a single slot through method 2, if there are multiple bundles of consecutive uplink symbols in the corresponding slot, respective repeated transmissions may be performed with regard to respective uplink symbol bundles. If there is a single bundle of consecutive uplink symbols in the corresponding slot, PUSCH repeated transmission is performed once according to the method of NR Release 15.
Method 3: two or more PUSCH repeated transmissions are scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repeated transmissions inside a single slot, or two or more PUSCH repeated transmissions across the boundary of consecutive slots may be supported. The number of repetitions indicated to the UE by the base station is only a nominal value, and the UE may actually perform a larger number of PUSCH repeated transmissions than the nominal number of repetitions. Time domain resource allocation information inside DCI or configured grant refers to resources of the first repeated transmission indicated by the base station. Time domain resource information of remaining repeated transmissions may be determined with reference to resource information of the first repeated transmission and the uplink or downlink direction of symbols. If time domain resource information of a repeated transmission indicated by the base station spans a slot boundary or includes an uplink/downlink switching point, the corresponding repeated transmission may be divided into multiple repeated transmissions. One repeated transmission may be included in one slot with regard to each uplink period.

### [PUSCH: Frequency Hopping Process]

Hereinafter, frequency hopping of a physical uplink shared channel (PUSCH) in a 5G system will be described below.

5G supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repeated transmission type A is a method in which a UE transmits allocated resources in the frequency domain, after changing the same by a configured frequency offset, by two hops in one slot. The start RB of each hop in connection with intra-slot frequency hopping may be expressed by Equation 3 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad Equation 3$$

In Equation 3, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}−└N_{symb}^{PUSCH,s}/2┘. N_{symb}^{PUSCH,s} is the length of PUSCH transmission in one slot and is expressed by the number of OFDM symbols.

Next, the inter-slot frequency hopping method supported in PUSCH repeated transmission types A and B is a method in which the UE transmits allocated resources in the frequency domain, after changing the same by a configured frequency offset, in each slot. The start RB during a slot in connection with inter-slot frequency hopping may be expressed by Equation 4 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad Equation 4$$

In Equation 4, nₛ^{μ} denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.
The inter-repetition frequency hopping method supported in PUSCH repeated transmission type B is a method in which resources allocated in the frequency domain regarding one or multiple actual repetitions in each nominal repetition are moved by a configured frequency offset and then transmitted. The index RBstart(n) of the start RB in the frequency domain regarding one or multiple actual repetitions in the nth nominal repetition may follow Equation 5 given below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad Equation 5$$

In Equation 5, n denotes the index of nominal repetition, and RB_{offset} denotes an RB offset between two hops through an upper layer parameter.

### [PUSCH: Multiplexing Rule During AP/SP CSI Reporting]

Hereinafter, a method of measuring and reporting a channel state in a 5G communication system will be described below. Channel state information (CSI) may include a channel quality information (CQI), a precoding matrix indicator (PMI), a CSI-RS resource indicator (CRI), a synchronization signal/physical broadcast channel (SS/PBCH) block resource indicator (SSBRI), a layer indicator (LI), a rank indicator (RI), and/or reference signal received power (L1-RSRP). The base station may control the time and frequency resources for the above-described CSI measurement and report of the UE.

For the CSI measurement and reporting, the UE may receive a configuration, via higher layer signaling, setting information for N(≥1) CSI reports (CSI-ReportConfig), setting info Cation for M(≥1) RS transport resources (CSI-ResourceConfig), and one or two pieces of trigger state list information (CSI-AperiodicTriggerStateList, CSI-SemiPersistentOnPUSCH-TriggerStateList). The configuration information for the above-described CSI measurement and reporting may be more specifically described in Tables 13 to 18 as follows.

TABLE 13
The IE CSI-ReportConfig is used to configure a periodic or semi-persistent report sent
on PUCCH on the cell in which the CSI-ReportConfig is included, or to configure a
semi-persistent or aperiodic report sent on PUSCH triggered by DCI received on the
cell in which the CSI-ReportConfig is included (in this case, the cell on which the report
is sent is determined by the received DCI). See TS 38.214 , clause 5.2.1.
CSI-ReportConfig information element
CSI-ReportConfig field descriptions

carrier
Indicates in which serving cell the CSI-ResourceConfig indicated below are to be found. If
the field is absent, the resources are on the same serving cell as this report configuration.
codebookConfig
Codebook configuration for Type-1 or Type-2 including codebook subset restriction.
Network does not configure codebookConfig and codebookConfig-r16 simultaneously to a UE
cqi-FormatIndicator
Indicates whether the UE shall report a single (wideband) or multiple (subband) CQI. (see
TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-ResourceConfig
included in the configuration of the serving cell indicated with the field “carrier” above. The
CSI-ResourceConfig indicated here contains only CSI-IM resources. The bwp-Id in that
CSI-ResourceConfig is the same value as the bwp-Id in the CSI-ResourceConfig indicated by
resourcesForChannelMeasurement.
csi-ReportingBand
Indicates a contiguous or non-contiguous subset of subbands in the bandwidth part which
CSI shall be reported for. Each bit in the bit-string represents one subband. The right-most
bit in the bit string represents the lowest subband in the BWP. The choice determines the
number of subbands (subbands3 for 3 subbands, subbands4 for 4 subbands, and so on) (see
TS 38.214 [19], clause 5.2.1.4). This field is absent if there are less than 24 PRBs (no sub
band) and present otherwise, the number of sub bands can be from 3 (24 PRBs, sub band
size 8) to 18 (72 PRBs, sub band size 4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked ResourceConfig
for channel measurement, a port indication for each rank R, indicating which R ports to use.
Applicable only for non-PMI feedback (see TS 38.214 [19], clause 5.2.1.4.2).
The first entry in non-PMI-PortIndication corresponds to the NZP-CSI-RS-Resource
indicated by the first entry in nzp-CSI-RS-Resources in the NZP-CSI-RS-ResourceSet
indicated in the first entry of nzp-CSI-RS-ResourceSetList of the CSI-ResourceConfig
whose CSI-ResourceConfigId is indicated in a CSI-MeasId together with the above
CSI-ReportConfigId; the second entry in non-PMI-PortIndication corresponds to the
NZP-CSI-RS-Resource indicated by the second entry in nzp-CSI-RS-Resources in the
NZP-CSI-RS-ResourceSet indicated in the first entry of nzp-CSI-RS-ResourceSetList
of the same CSI-ResourceConfig, and so on until the NZP-CSI-RS-Resource indicated by the
last entry innzp-CSI-RS-Resources in the in the NZP-CSI-RS-ResourceSet indicated in the
first entry of nzp-CSI-RS-ResourceSetList of the same CSI-ResourceConfig. Then the next
entry corresponds to the NZP-CSI-RS-Resource indicated by the first entry in
nzp-CSI-RS-Resources in the NZP-CSI-RS-ResourceSet indicated in the second entry of
nzp-CSI-RS-ResourceSetList of the same CSI-ResourceConfig and so on.
nrofReportedRS
The number (N) of measured RS resources to be reported per report setting in a non-group-based
report. N <= N_max, where N_max is either 2 or 4 depending on UE capability.
(see TS 38.214 [19], clause 5.2.1.4) When the field is absent the UE applies the value 1.
nzp-CSI-RS-ResourcesForInterference
NZP CSI RS resources for interference measurement. csi-ResourceConfigId of a
CSI-ResourceConfig included in the configuration of the serving cell indicated
with the field “carrier” above. The CSI-ResourceConfig indicated here contains only
NZP-CSI-RS resources. The bwp-Id in that CSI-ResourceConfig is the same value as the
bwp-Id in the CSI-ResourceConfig indicated by resourcesForChannelMeasurement.
p0alpha
Index of the p0-alpha set determining the power control for this CSI report transmission
(see TS 38.214 [19], clause 6.2.1.2).
pdsch-BundleSizeForCSI
PRB bundling size to assume for CQI calculation when reportQuantity is CRI/RI/i1/CQI. If
the field is absent, the UE assumes that no PRB bundling is applied (see TS 38.214 [19],
clause 5.2.1.4.2).
pmi-FormatIndicator
Indicates whether the UE shall report a single (wideband) or multiple (subband) PMI.
(see TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1. If the field
reportQuantity-r16 is present, UE shall ignore reportQuantity (without suffix).
reportSlotConfig
Periodicity and slot offset (see TS 38.214 [19], clause 5.2.1.4). If the field
reportSlotConfig-v1530 is present, the UE shall ignore the value provided in reportSlotConfig
(without suffix). reportSlotOffsetList, reportSlotOffsetListDCI-0-1, reportSlotOffsetListDCI-0-2
Timing offset Y for semi persistent reporting using PUSCH. This field lists the allowed offset
values. This list must have the same number of entries as the pusch-TimeDomainAllocationList
in PUSCH-Config. A particular value is indicated in DCI. The network indicates in the DCI
field of the UL grant, which of the configured report slot offsets the UE shall apply. The DCI
value 0 corresponds to the first report slot offset in this list, the DCI value 1 corresponds to the
second report slot offset in this list, and so on. The first report is transmitted in slot n + Y,
second report in n + Y + P, where P is the configured periodicity. Timing offset Y for aperiodic
reporting using PUSCH. This field lists the allowed offset values. This list must have the same
number of entries as the pusch-TimeDomainAllocationList in PUSCH-Config. A particular
value is indicated in DCI. The network indicates in the DCI field of the UL grant, which of the
configured report slot offsets the UE shall apply. The DCI value 0 corresponds to the first
report slot offset in this list, the DCI value 1 corresponds to the second report slot offset in this
list, and so on (see TS 38.214 [19], clause 6.1.2.1). The field reportSlotOffsetList applies to
DCI format 0_0, the field reportSlotOffsetListDCI-0-1 applies to DCI format 0_1 and the field
reportSlotOffsetListDCI-0-2 applies to DCI format 0_2 (see TS 38.214 [19], clause 6.1.2.1).
resourcesForChannelMeasurement
Resources for channel measurement. csi-ResourceConfigId of a CSI-ResourceConfig
included in the configuration of the serving cell indicated with the field “carrier” above. The
CSI-ResourceConfig indicated here contains only NZP-CSI-RS resources and/or SSB
resources. This CSI-ReportConfig is associated with the DL BWP indicated by bwp-Id in
that CSI-ResourceConfig.
subbandSize
Indicates one out of two possible BWP-dependent values for the subband size as indicated in
TS 38.214 [19], table 5.2.1.4-2 . If csi-ReportingBand is absent, the UE shall ignore this field.
timeRestrictionForChannelMeasurements
Time domain measurement restriction for the channel (signal) measurements (see TS 38.214
[19], clause 5.2.1.1).
timeRestrictionForInterferenceMeasurements
Time domain measurement restriction for interference measurements (see TS 38.214 [19],
clause 5.2.1.1).

TABLE 14
The IE CSI-ResourceConfig defines a group of
one or more NZP-CSI-RS-ResourceSet,
CSI-IM-ResourceSet and/or CSI-SSB-ResourceSet.
CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-

| | |
|---|---|
| ResourceSetsPerConfig)) OF NZP-CSI-RS-ResourceSetId | OPTIONAL, |

-- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP
CSI-ResourceConfig field descriptions
bwp-Id
The DL BWP which the CSI-RS associated with this CSI-ResourceConfig are located in (see
TS 38.214 [19], clause 5.2.1.2.
csi-IM-ResourceSetList
List of references to CSI-IM resources used for beam measurement and reporting in a
CSI-RS resource set. Contains up to maxNrofCSI-IM-ResourceSetsPerConfig resource
sets if resourceType is ‘aperiodic’ and 1 otherwise (see TS 38.214 [19], clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and reporting in a CSI-RS
resource set (see TS 38.214 [19], clause 5.2.1.2).
nzp-CSI-RS-ResourceSetList
List of references to NZP CSI-RS resources used for beam measurement and reporting in a
CSI-RS resource set. Contains up to maxNrofNZP-CSI-RS-ResourceSetsPerConfig resource
sets if resourceType is ‘aperiodic’ and 1 otherwise (see TS 38.214 [19], clause 5.2.1.2).
resourceType
Time domain behavior of resource configuration (see TS 38.214 [19], clause 5.2.1.2). It does
not apply to resources provided in the csi-SSB-ResourceSetList.

TABLE 15
The IE NZP-CSI-RS-ResourceSet is a set of Non-Zero-Power (NZP) CSI-RS resources
(their IDs) and set-specific parameters.
NZP-CSI-RS-ResourceSet information element

| -- ASN1START | |
|---|---|
| -- TAG-NZP-CSI-RS-RESOURCESET-START | |
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI- |

RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
OPTIONAL, -- Need R
  ...,
  [[
```

| | |
|---|---|
| aperiodicTriggeringOffset-r16 | INTEGER(0..31) |

OPTIONAL -- Need S
]]
}
-- TAG-NZP-CSI-RS-RESOURCESET-STOP
-- ASN1STOP

NZP-CSI-RS-ResourceSet field descriptions
aperiodicTriggeringOffset, aperiodicTriggeringOffset-r16
Offset X between the slot containing the DCI that triggers a set of aperiodic NZP CSI-RS
resources and the slot in which the CSI-RS resource set is transmitted. For
aperiodicTriggeringOffset, the value 0 corresponds to 0 slots, value 1 corresponds to 1 slot,
value 2 corresponds to 2 slots, value 3 corresponds to 3 slots, value 4 corresponds to 4 slots,
value 5 corresponds to 16 slots, value 6 corresponds to 24 slots. For
aperiodicTriggeringOffset-r16, the value indicates the number of slots. The network
configures only one of the fields. When neither field is included, the UE applies the value 0.
nzp-CSI-RS-Resources
NZP-CSI-RS-Resources associated with this NZP-CSI-RS resource set (see TS 38.214 [19],
clause 5.2). For CSI, there are at most 8 NZP CSI RS resources per resource set.
repetition
Indicates whether repetition is on/off. If the field is set to off or if the field is absent, the UE
may not assume that the NZP-CSI-RS resources within the resource set are transmitted with
the same downlink spatial domain transmission filter (see TS 38.214 [19], clauses 5.2.2.3.1
and 5.1.6.1.2). It can only be configured for CSI-RS resource sets which are associated with
CSI-ReportConfig with report of L1 RSRP or “no report”.
trs-Info
Indicates that the antenna port for all NZP-CSI-RS resources in the CSI-RS resource set is
same. If the field is absent or released the UE applies the value false (see TS 38.214 [19],
clause 5.2.2.3.1).

TABLE 15-1
The IE CSI-SSB-ResourceSet is used to configure
one SS/PBCH block resource set which refers to
SS/PBCH as indicated in ServingCellConfigCommon.
CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI- |

SSB-ResourcePerSet)) OF SSB-Index,
...
}
-- TAG-CSI-SSB-RESOURCESET-STOP
-- ASN1STOP

TABLE 16
The IE CSI-IM-ResourceSet is used to configure a set
of one or more CSI Interference Management (IM)
resources (their IDs) and set-specific parameters.
CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

ResourcesPerSet)) OF CSI-IM-ResourceId,
...
}
-- TAG-CSI-IM-RESOURCESET-STOP
-- ASN1STOP

CSI-IM-ResourceSet field descriptions
csi-IM-Resources
CSI-IM-Resources associated with this CSI-IM-ResourceSet
(see TS 38.214 [19], clause 5.2)

TABLE 17
The CSI-AperiodicTriggerStateList IE is used to configure the UE with a list of
aperiodic trigger states. Each codepoint of the DCI field “CSI request” is associated
with one trigger state. Upon reception of the value associated with a trigger state, the
UE will perform measurement of CSI-RS (reference signals) and aperiodic reporting on
L1 according to all entries in the associatedReportConfigInfoList for that trigger state.
CSI-AperiodicTriggerStateList information element

-- ASN1START
-- TAG-CSI-APERIODICTRIGGERSTATELIST-START
CSI-AperiodicTriggerStateList ::= SEQUENCE (SIZE (1..maxNrOfCSI-
AperiodicTriggers)) OF CSI-AperiodicTriggerState
CSI-AperiodicTriggerState ::= SEQUENCE {

| | |
|---|---|
| associatedReportConfigInfoList | SEQUENCE |
| (SIZE(1..maxNrofReportConfigPerAperiodicTrigger)) | OF CSI- |

AssociatedReportConfigInfo,
...
}
CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |

| | |
|---|---|
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |

| | |
|---|---|
| ResourceSetsPerConfig) | OPTIONAL, -- Cond CSI-IM-ForInterference |

```
  nzp-CSI-RS-ResourcesForInterference INTEGER (1..maxNrofNZP-CSI-RS-
ResourceSetsPerConfig) OPTIONAL, -- Cond NZP-CSI-RS-ForInterference
  ...
}
-- TAG-CSI-APERIODICTRIGGERSTATELIST-STOP
-- ASN1STOP
```

| CSI-AssociatedReportConfigInfo field descriptions | |
|---|---|
| csi-IM-ResourcesForInterference | |
| CSI-IM-ResourceSet for interference measurement. Entry number in csi-IM- | |
| ResourceSetList in the CSI-ResourceConfig indicated by csi-IM- | |
| ResourcesForInterference in the CSI-ReportConfig indicated by reportConfigId above (1 | |
| corresponds to the first entry, 2 to the second entry, and so on). The indicated CSI-IM- | |
| ResourceSet should have exactly the same number of resources like the NZP-CSI-RS- | |
| ResourceSet indicated in nzp-CSI-RS-ResourcesforChannel. | |
| csi-SSB-ResourceSet | |
| CSI-SSB-ResourceSet for channel measurements. Entry number in csi-SSB- | |
| ResourceSetList in the CSI-ResourceConfig indicated by | |
| resourcesForChannelMeasurement in the CSI-ReportConfig indicated by reportConfigId | |
| above (1 corresponds to the first entry, 2 to the second entry, and so on). | |
| nzp-CSI-RS-ResourcesForInterference | |
| NZP-CSI-RS-ResourceSet for interference measurement. Entry number in nzp-CSI-RS- | |
| ResourceSetList in the CSI-ResourceConfig indicated by nzp-CSI-RS- | |
| ResourcesForInterference in the CSI-ReportConfig indicated by reportConfigId above (1 | |
| corresponds to the first entry, 2 to the second entry, and so on). | |
| qcl-info | |
| List of references to TCI-States for providing the QCL source and QCL type for each | |
| NZP-CSI-RS-Resource listed in nzp-CSI-RS-Resources of the NZP-CSI-RS-ResourceSet | |
| indicated by nzp-CSI-RS-ResourcesforChannel. Each TCI-StateId refers to the TCI-State | |
| which has this value for tci-StateId and is defined in tci-StatesToAddModList in the | |
| PDSCH-Config included in the BWP-Downlink corresponding to the serving cell and to | |
| the DL BWP to which the resourcesForChannelMeasurement (in the CSI-ReportConfig | |
| indicated by reportConfigId above) belong to. First entry in qcl-info-forChannel | |
| corresponds to first entry in nzp-CSI-RS-Resources of that NZP-CSI-RS-ResourceSet, | |
| second entry in qcl-info-forChannel corresponds to second entry in nzp-CSI-RS- | |
| Resources, and so on (see TS 38.214 [19], clause 5.2.1.5.1) | |
| reportConfigId | |
| The reportConfigId of one of the CSI-ReportConfigToAddMod configured in CSI- | |
| MeasConfig | |
| resourceSet | |
| NZP-CSI-RS-ResourceSet for channel measurements. Entry number in nzp-CSI-RS- | |
| ResourceSetList in the CSI-ResourceConfig indicated by | |
| resourcesForChannelMeasurement in the CSI-ReportConfig indicated by reportConfigId | |
| above (1 corresponds to the first entry, 2 to the second entry, and so on). | |
| Conditional Presence | Explanation |
| Aperiodic | The field is mandatory present if the NZP-CSI-RS- |
| | Resources in the associated resourceSet have the |
| | resourceType aperiodic. The field is absent otherwise. |
| CSI-IM-ForInterference | This field is optional need M if the CSI-ReportConfig |
| | identified by reportConfigId is configured with csi-IM- |
| | ResourcesForInterference; otherwise it is absent. |
| NZP-CSI-RS- | This field is optional need M if the CSI-ReportConfig |
| ForInterference | identified by reportConfigId is configured with nzp-CSI-RS- |
| | ResourcesForInterference; otherwise it is absent. |

TABLE 18
The CSI-SemiPersistentOnPUSCH-TriggerStateList IE is used to configure
the UE with list of trigger states for semi-persistent reporting of
channel state information on L1. See also TS 38.214 [19], clause 5.2.

-- ASN1START
-- TAG-CSI-SEMIPERSISTENTONPUSCHTRIGGERSTATELIST-START

| | |
|---|---|
| CSI-SemiPersistentOnPUSCH-TriggerStateList ::= | SEQUENCE(SIZE |

(1..maxNrOfSemiPersistentPUSCH-Triggers)) OF CSI-SemiPersistentOnPUSCH-
TriggerState
CSI-SemiPersistentOnPUSCH-TriggerState ::= SEQUENCE

| | |
|---|---|
| associatedReportConfigInfo | CSI-ReportConfigId, |

...
}
-- TAG-CSI-SEMIPERSISTENTONPUSCHTRIGGERSTATELIST-STOP
-- ASN1STOP

Regarding the aforementioned CSI report setting (CSI-ReportConfig), each report setting (CSI-ReportConfig) may be associated with CSI resource setting associated with corresponding report setting and one downlink (DL) bandwidth part (BWP) identified by a higher layer parameter bwp-id given by CSI-ResourceConfig. A time-domain reporting operation with respect to each report setting (CSI-ReportConfig) may support an ‘aperiodic’, ‘semi-persistent’, or ‘periodic’ scheme, and may be configured from the base station for the UE by a reportConfigType parameter configured by a higher layer. A semi-persistent CSI reporting method supports a PUCCH-based semi-persistent (semi-PersistentOnPUCCH) reporting method or a PUSCH-based semi-persistent (semi-PersistentOnPUSCH) reporting method. According to the periodic or semi-persistent CSI reporting method, the UE may be configured, from the base station via higher layer signaling, with a PUCCH or PUSCH resource to transmit CSI. Periodicity and slot offset of the PUCCH or PUSCH resource to transmit CSI may be given by numerology of an uplink (UL) BWP configured for transmission of a CSI report. According to the aperiodic CSI reporting method, the UE may receive, from the base station via L1 signaling (DCI format 0_1 described above), scheduling of a PUSCH resource to transmit CSI.

Regarding the CSI resource setting (CSI-ResourceConfig), each CSI resource setting CSI-ReportConfig may include S(≥1) CSI resource sets (given by higher layer parameter csi-RS-ResourceSetList). The CSI resource set list may be configured by a non-zero power (NZP) CSI-RS resource set and an SS/PBCH block set or may be configured by a CSI-interference measurement (CSI-IM) resource set. Each CSI resource setting may be located on a DL BWP identified by higher layer parameter bwp-id, and CSI resource setting may be associated with CSI report setting of the same DL BWP. A time-domain operation of a CSI-RS resource in the CSI resource setting may be configured to be one of ‘aperiodic’, ‘periodic’ or ‘semi-persistent’ via higher layer parameter resourceType. For the periodic or semi-persistent CSI resource setting, the number of CSI-RS resource sets may be limited to S=1, and the configured periodicity and slot offset may be given by numerology of the DL BWP identified by bwp-id. The UE may be configured, from the base station via higher layer signaling, with one or more CSI resource settings for channel or interference measurement, and for example, the CSI resource settings may include CSI resources below.
CSI-IM resource for interference measurement
NZP CSI-RS resource for interference measurement
NZP CSI-RS resource for channel measurement

For CSI-RS resource sets associated with resource setting configured to be ‘aperiodic’, ‘periodic’ or ‘semi-persistent’ by higher layer parameter resourceType, a trigger state with respect to CSI report setting in which reportType is configured to be ‘aperiodic’ and resource setting for channel or interference measurement of one or multiple component cells (CCs) may be configured by higher layer parameter CSI-AperiodicTriggerStateList.

The aperiodic CSI reporting of the UE may be performed by using a PUSCH, the periodic CSI reporting of the UE may be performed by using a PUCCH, and when the semi-persistent CSI reporting is triggered or activated by DCI, the semi-persistent CSI reporting may be performed by using a PUSCH after the semi-persistent CSI reporting is activated by a MAC control element (CE). As described above, CSI resource setting may also be configured to be ‘aperiodic’, ‘periodic’ or ‘semi-persistent’. Combinations of the CSI report setting and the CSI resource setting may be supported based on Table 19 below. Table 19 describes the “Triggering/Activation of CSI Reporting for the possible CSI-RS Configuration”.

TABLE 19

| CSI-RS | Periodic CSI | Semi-Persistent CSI | Aperiodic CSI |
|---|---|---|---|
| Configuration | Reporting | Reporting | Reporting |
| Periodic | No dynamic | For reporting on | Triggered by DCI; |
| CSI-RS | triggering/ | PUCCH, the UE | additionally, |
| | activation | receives an | activation command |
| | | activation command | [10, TS 38.321] |
| | | [10, TS 38.321]; for | possible as defined |
| | | reporting on | in Subclause |
| | | PUSCH, the UE | 5.2.1.5.1. |
| | | receives triggering | |
| | | on DCI | |
| Semi-Persistent | Not | For reporting on | Triggered by DCI; |
| CSI-RS | Supported | PUCCH, the UE | additionally, |
| | | receives an | activation command |
| | | activation command | [10, TS 38.321] |
| | | [10, TS 38.321]; for | possible as defined |
| | | reporting on | in Subclause |
| | | PUSCH, the UE | 5.2.1.5.1. |
| | | receives triggering | |
| | | on DCI | |
| Aperiodic | Not | Not Supported | Triggered by DCI; |
| CSI-RS | Supported | | additionally, |
| | | | activation command |
| | | | [10, TS 38.321] |
| | | | possible as defined |
| | | | in Subclause |
| | | | 5.2.1.5.1. |

The aperiodic CSI reporting may be triggered by “CSI request” field of the aforementioned DCI format 0_1 corresponding to scheduling DCI with respect to a PUSCH. The UE may monitor a PDCCH, may obtain DCI format 0_1, and may obtain scheduling information with respect to a PUSCH and a CSI request indicator. The CSI request indicator may be configured with NTS (=0, 1, 2, 3, 4, 5, or 6) bits, and may be determined by higher layer signaling (reportTriggerSize). One trigger state from among one or more aperiodic CSI report trigger states configurable by higher layer signaling (CSI-AperiodicTriggerStateList) may be triggered by the CSI request indicator.
When all bits of the CSI request field are 0, this may indicate that a CSI report is not requested.
If the number (M) of CSI trigger states in configured CSI-AperiodicTriggerStateLite is greater than 2NTs-1, M CSI trigger states may be mapped to 2NTs-1 according to a predefined mapping relation, and one trigger state from among 2NTs-1 CSI trigger states may be indicated by the CSI request field.
If the number (M) of CSI trigger states in configured CSI-AperiodicTriggerStateLite is equal to or smaller than 2NTs-1, one of M CSI trigger states may be indicated by the CSI request field.

Table 20 below shows an example of a relation between a CSI request indicator and a CSI trigger state indicative by the indicator.

TABLE 20

| CSI | | | |
|---|---|---|---|
| request | CSI trigger | CSI- | CSI- |
| field | state | ReportConfigId | ResourceConfigId |
| 00 | no CSI | N/A | N/A |
| | request | | |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The UE may perform measurement on a CSI resource in the CSI trigger state triggered by the CSI request field, and may generate CSI (including at least one of CQI, PMI, CRI, SSBRI, LI, RI, or L1-RSRP described above) from a result of the measurement. The UE may transmit the obtained CSI by using the PUSCH scheduled by the corresponding DCI format 0_1. When one bit corresponding to a UL data indicator (UL-SCH indicator) in the DCI format 0_1 indicates “1”, the UE may multiplex UL data (UL-SCH) and the obtained CSI with a PUSCH resource scheduled by the DCI format 0_1 and may transmit the same. When one bit corresponding to a UL data indicator (UL-SCH indicator) in the DCI format 0_1 indicates “0”, the UE may map only the CSI to a PUSCH resource scheduled by the DCI format 0_1, without UL data (UL-SCH), and may transmit the same.

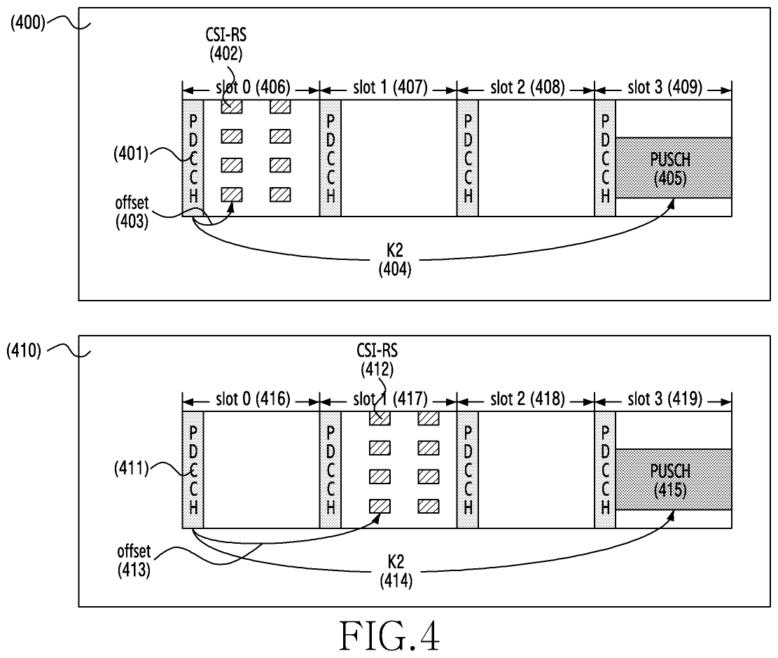

FIG. 4 illustrates an aperiodic CSI reporting method according to an embodiment of the disclosure.

Referring to 400 of FIG. 4, the UE may obtain DCI format 0_1 by monitoring a PDCCH 401, and may obtain, from the DCI format 0_1, scheduling information with respect to a PUSCH 405 and CSI request information. The UE may obtain, from the received CSI request indicator, resource information with respect to a CSI-RS 402 to be measured. The UE may determine at what time point to measure a transmitted CSI-RS resource 402, based on a time point of reception of the DCI format 0_1 and a parameter (aforementioned aperiodicTriggeringOffset) with respect to offset 403 or 413 in CSI resource set configuration (e.g., NZP CSI-RS resource set configuration (NZP-CSI-RS-ResourceSet)). More specifically, the UE may be configured, from the base station via higher layer signaling, with an offset value X of parameter aperiodicTriggeringOffset in NZP-CSI-RS resource set configuration, and the configured offset value X may indicate offset 403 or 413 between a slot in which DCI to trigger an aperiodic CSI report is received and a slot in which a CSI-RS resource is to be transmitted. For example, a value of the parameter aperiodicTriggeringOffset and the offset value X may have mapping relations described in Table 21 below.

TABLE 21

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

In the example 400 of FIG. 4, an example is shown in which the offset value is configured as X=0. In this case, the UE may receive a CSI-RS 402 in a slot (corresponding to a slot 0 406 of FIG. 4) in which the DCI format 0_1 triggering the aperiodic CSI report is received, and may report CSI information, measured by the received CSI-RS, through a PUSCH 405 to the base station. The UE may obtain, from the DCI format 0_1, scheduling information (pieces of information respectively corresponding to fields of the DCI format 0_1) with respect to the PUSCH 405 for a CSI report. For example, the UE may obtain information about a slot in which the PUSCH 405 is to be transmitted, from the time-domain resource allocation information of the DCI format 0_1 with respect to the PUSCH 405. In the example 400 of FIG. 3, the UE may obtain a value of 3 as K2 value 404 and 414 corresponding to a slot offset value for PDCCH-to-PUSCH, and thus, the PUSCH 405 may be transmitted in a slot 3 409 or 419 that is separated, by 3 slots (i.e., slot 1 407 or 417 and slot 2 408 or 418), from the slot 0 406 in which the PDCCH 401 is received.

In an example 410 of FIG. 4, the UE may obtain DCI format 0_1 by monitoring a PDCCH 411, and may obtain, from the DCI format 0_1, scheduling information with respect to a PUSCH 405 or 415 and CSI request information. The UE may obtain, from a received CSI request indicator, resource information with respect to a CSI-RS 412 to be measured. In the example 410 of FIG. 4, the aforementioned offset value for CSI-RS is configured as X=1. In this case, the UE may receive the CSI-RS 412 in a slot (corresponding to slot 0 416 of FIG. 4) in which the DCI format 0_1 triggering an aperiodic CSI report is received, and may report, to the base station via the PUSCH 405 or 415, CSI information measured by using the received CSI-RS.

The aperiodic CSI report may include at least one of CSI part 1 or CSI part 2 or both CSI part 1 and CSI part 2, and when the aperiodic CSI report is to be transmitted via a PUSCH, the aperiodic CSI report and a transport block may be multiplexed. For the multiplexing, a CRC may be inserted into an input bit of aperiodic CSI, and then encoding and rate matching may be performed thereon, and thereafter, the input bit may be mapped with a particular pattern to a resource element in a PUSCH and transmitted. The CRC insertion may be omitted depending on a coding method or a length of input bits. The number of modulation symbols to be calculated for rate matching in multiplexing of CSI part 1 or CSI part 2 included in the aperiodic CSI report may be calculate as in Table 22 below

TABLE 22
For CSI part 1 transmission on PUSCH not using repetition type B with UL-SCH, the
number of coded modulation symbols per layer for CSI part 1 transmission, denote
das Q_{CSI-part1}′, is determined as follows:

| | |
|---|---|
| ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{SC}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$ | Equation 6 |

For CSI part 1 transmission on an actual repetition of a PUSCH with repetition Type
B with UL-SCH, the number of coded modulation symbols per layer for CSI part 1
transmission, denoted as Q_{CSI-part1}′, is determined as follows:

| | |
|---|---|
| ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , {actual}^{- 1}}^{PUSCH}} {M}_{sc , actual}^{UCI} ( l ) - {Q}_{ACK / CG - UCI}^{′} \}$ | Equation 7 |

For CSI part 1 transmission on PUSCH without UL-SCH, the number of coded
modulation symbols per layer for CSI part 1 transmission, denoted as Q_{CSI-part1}, is
determined as follows:
if there is CSI part 2 to be transmitted on the PUSCH,

| | |
|---|---|
| ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$ | Equation 8 |

else

${Q}_{CSI - 1}^{′} = {\sum }_{l = 0}^{{N}_{symb , all}^{PUSCH} - 1} {M}_{sc}^{UCI} ( l ) - {Q}_{ACK}^{′}$

end if
For CSI part 2 transmission on PUSCH not using repetition type B with UL-SCH,
the number of coded modulation symbols per layer for CSI part 2 transmission,
denoted as Q_{CSI-part2}′, is determined as follows:

| | |
|---|---|
| ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{U L - S C H} - 1} {K}_{r}} ⌉ , ⌈ α \cdot {\sum }_{l = 0}^{{N}_{symb , all}^{PUSCH} - 1} {M}_{s c}^{UCI} ( l ) ⌉ - {Q}_{ACK / CG - UCI}^{′} - {Q}_{CSI - 1}^{′} \} \qquad \\$ | Equation 9 |

For CSI part 2 transmission on an actual repetition of a PUSCH with repetition Type
B with UL-SCH, the number of coded modulation symbols per layer for CSI part 2
transmission, denoted as Q_{CSI-part2}′, is determined as follows:

| | |
|---|---|
| ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{U C I} ( l ) ⌉ - {Q}_{ACK / CG - UCI}^{′} - {Q}_{CSI - 1}^{′} , {\sum }_{l = 0}^{{N}_{symb , {actual}^{- 1}}^{PUSCH}} {M}_{sc , actual}^{UCI} ( l ) - {Q}_{ACK / CG - UCI}^{′} - {Q}_{CSI - 1}^{′} \}$ | Equation 10 |

For CSI part 2 transmission on PUSCH without UL-SCH, the number of coded
modulation symbols per layer for CSI part 2 transmission, denoted as Q_{CSI-part2}′, is
determined as follows:

| | |
|---|---|
| ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$ | Equation 11 |

More particularly, in a case of PUSCH repeated transmission types A and B, the UE may multiplex and transmit the aperiodic CSI report only in first repeated transmission from among PUSCH repeated transmissions. The aperiodic CSI report information to be multiplexed is encoded by using a polar code scheme, and here, in order to multiplex the aperiodic CSI report information for multiple PUSCH repetitions, each of the PUSCH repetitions needs to have the same frequency and time resource allocation, and in particular, in a case of the PUSCH repetition type B, each actual repetition may have a different OFDM symbol length and thus the aperiodic CSI report may be multiplexed and transmitted only in first PUSCH repetition.

In addition, for the PUSCH repetition type B, in case that the UE receives DCI to schedule the aperiodic CSI report or to activate a semi-persistent CSI report without scheduling of a transport block, even when the number of PUSCH repeated transmissions configured by higher layer signaling is greater than 1, the UE may assume a value of nominal repetition as 1. In addition, when the aperiodic or semi-persistent CSI report is scheduled or activated by the UE without scheduling of a transport block based on the PUSCH repetition type B, the UE may expect that first nominal repetition is the same as first actual repetition. For a PUSCH being transmitted while including semi-persistent CSI based on the PUSCH repetition type B without scheduling of DCI after the semi-persistent CSI report is activated by DCI, in case that first nominal repetition is different from first actual repetition, transmission with respect to the first nominal repetition may be ignored.

### [PUCCH: UCI on PUSCH]

In an NR communication system, in case that a uplink control channel overlaps an uplink data channel and a transmission time condition is satisfied, or that uplink control information is indicated to be transmitted to an uplink data channel via L1 signaling or higher layer signaling, the uplink control information may be transmitted while being included in the uplink data channel. In this case, a total of three pieces of uplink control information of HARQ-ACK, CSI part 1, and CSI part 2 may be transmitted via the uplink data channel, and each piece of uplink control information may be mapped to a PUSCH according to a predetermined multiplexing rule.

More specifically, in a first step, in case that the number of bits of HARQ-ACK information to be included in the PUSCH is 2 bits or less, the UE reserves an RE for transmission of HARQ-ACK in advance. In this case, a method of determining a resource to be reserved is the same as that of a second step. However, the number and location of the REs to be reserved are determined on the assumption that the number of bits of HARQ-ACK is 2. For example, in Equation 9, the number and location of the REs to be reserved are calculated based on that Oack=2. In the second step, in case that the number of bits of HARQ-ACK information to be transmitted by the UE is more than 2 bits, the UE may perform mapping of HARQ-ACK from a first OFDM symbol not including a DMRS after the first DMRS symbol. In a third step, the UE may map CSI part 1 to the PUSCH. In this case, CSI part 1 may be mapped starting from a first OFDM symbol other than the DMRS, and may not be mapped to the RE reserved in the first step and the RE to which HARQ-ACK is mapped in the second step.

In a fourth step, the UE may map CSI part 2 to the PUSCH. In this case, CSI part 2 may be mapped starting from the first OFDM symbol other than the DMRS, and may not be mapped to the RE in which CSI part 1 is located and the RE in which the HARQ-ACK mapped to the RE in the second step is located. However, CSI part 2 may be mapped to the RE reserved in the first step. In case that UL-SCH exists, the UE may map the UL-SCH to the PUSCH. In this case, the UL-SCH may be mapped starting from the first OFDM symbol other than the DMRS, and may not be mapped to the RE in which the CSI part 1 is located, the RE in which the HARQ-ACK mapped to the RE in the second step is located, and the RE in which the CSI part 2 is located. However, the CSI part 2 may be mapped to the RE reserved in the first step.

In a fifth step, in case that HARQ-ACK is smaller than 2 bits, the UE may map the HARQ-ACK to the RE reserved in the first step by puncturing. The number of REs to which the HARQ-ACK is mapped is calculated based on the actual number of HARQ-ACKs. In other words, the number of REs to which the HARQ-ACK is mapped may be smaller than the number of reserved REs in the first step. The puncturing of the HARQ-ACK may signify that even if, in the fourth step, CSI part 2 or UL-SCH has been considered as the RE to which the HARQ-ACK is to be mapped, the HARQ-ACK is mapped to the RE instead of the pre-mapped CSI part 2 or UL-SCH. CSI part 1 is not mapped to the reserved RE to prevent puncturing by the HARQ-ACK from occurring. This signifies that CSI part 1 has a higher priority than CSI part 2 and is decoded better than CSI part 2. In addition, when the number of bits of uplink control information (or the number of modulated symbols) to be mapped to a PUSCH is greater than the number of bits (or REs) which enable uplink control information mapping in the corresponding OFDM symbol to be mapped, the frequency-axis RE interval d between modulated symbols of the uplink control information to be mapped may be configured such that d=1. In case that the number of bits of the uplink control information (or number of modulated symbols) to be mapped by the UE to a PUSCH is less than the number of bits (or RE0) which enable uplink control information mapping in the corresponding OFDM symbol to be mapped, the frequency-axis RE interval d between the modulated symbols of the uplink control information to be mapped may be configured such that d=floor(# of available bits on 1-OFDM symbol/# of unmapped UCI bits at the beginning of 1-OFDM symbol).

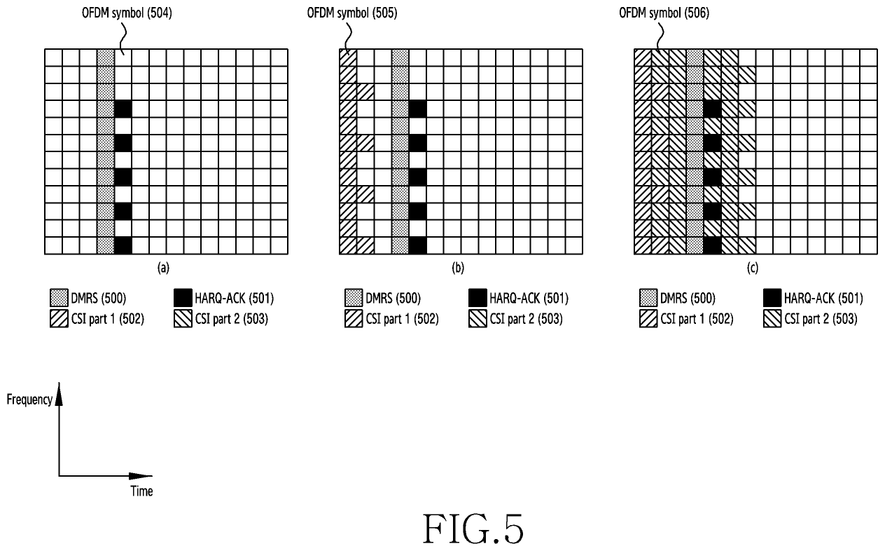

FIG. 5 illustrates an example in which uplink control information is mapped to a PUSCH according to an embodiment of the disclosure.

Referring to FIG. 5, the number of HARQ-ACK symbols to be mapped to a PUSCH is assumed to be five, and the PUSCH is assumed to have one resource block configured or scheduled. First, the UE may perform mapping of a HARQ-ACK 501 of the five symbols from a lowest RE index (or a highest RE index) of a first OFDM symbol 504 not including a DMRS 500 after a first DMRS at an RE interval of d=floor(12/5)=2 on the frequency axis, as shown in (a) of FIG. 5. Next, the UE may map CSI part 1 502 from a first OFDM symbol 505 other than a DMRS 500, as shown in (b) of FIG. 5. Finally, the UE may map CSI part 2 503 to an RE in which CSI part 1 and HARQ-ACK are not mapped, starting from the first OFDM symbol 506 not including a DMRS 500, as shown in (c) of FIG. 5.

On the other hand, when the HARQ-ACK is transmitted to a PUSCH (or CG-PUSCH), the number of encoded modulation symbols may be determined by the following Equation 12.

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} \qquad Equation 12$$

Here, O_{ACK} represents the number of bits of a payload of HARQ-ACK, and L_{ACK} represents the number of bits of CRC. More specifically, O_{ACK}≥360, L_{ACK}=11; otherwise 360>O_{ACK}≥20, L_{ACK}=11, 20>O_{ACK}≥12, L_{ACK}=6, and 12>O_{ACK}, L_{ACK}=0. Kᵣ represents the size of an r-th code block of a UL-SCH, and M_{sc}^{UCI} represents the number of subcarriers for each OFDM symbol that is usable for UCI transmission in a PUSCH configured or scheduled by the base station. In addition, α and β_{offset}^{PUSCH} are values configured by the base station and are determined via higher layer signaling or L1 signaling. More specifically, β_{offset}^{PUSCH}, that is, a value of beta offset is a value defined to determine the number of resources when the HARQ-ACK information is multiplexed together with other UCI information to be transmitted to a PUSCH (or CG-PUSCH). In case that fallback DCI (or DCI format 0_0) or non-fallback DCI (or DCI format 0_1) not including a beta_offset indicator field indicates PUSCH transmission and the UE has configured the beta offset value configuration as ‘semi-static’ via higher layer configuration, the UE may have one beta offset value configured as a higher layer configuration. In this case, the beta offset has a value given in Table 23, may indicate the index of the corresponding value via higher layer configuration, and depending on the number of bits in the HARQ-ACK information, the index I_{offset,0}^{HARQ-ACK}, I_{offset,1}^{HARQ-ACK}, and I_{offset,2}^{HARQ-ACK} may have beta offset values for the cases in which the number of bits of HARQ-ACK information is 2 or less, greater than 2 and smaller than or equal to 11, and greater than 11, respectively. In addition, it is possible to configure the beta offset values for CSI part 1 and CSI part 2 in the same manner. There is an effect of regulating a code rate of UCI compared to an effective code rate of a UL-SCH by the beta offset value. In other words, in case that the beta offset has a value of 2, the code rate of (index=1) UCI may be configured to be transmitted at a lower code rate by ½ than an effective code rate of the UL-SCH.

TABLE 23

| I_{offset, 0}^{HARQ-ACK} or | |
|---|---|
| I_{offset, 1}^{HARQ-ACK} or | |
| I_{offset, 2}^{HARQ-ACK} | β_{offset}^{HARQ-ACK} |
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | Reserved |
| 17 | Reserved |
| 18 | Reserved |
| 19 | Reserved |
| 20 | Reserved |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

In case that the base station schedules PUSCH transmission to the UE by using non-fallback DCI (or DCI format 0_1) and the non-fallback DCI has a beta offset indicator field, i.e., the beta offset value configuration is configured as ‘dynamic’ via higher layer configuration, the base station may configure, in the case of HARQ-ACK, the beta offset values for four sets having I_{offset,0}^{HARQ-ACK} or I_{offset,1}^{HARQ-ACK}, or I_{offset,2}^{HARQ-ACK} as shown in Table 24 and configure the same for the UE. Further, the UE may indicate the beta offset value to be used for HARQ-ACK multiplexing, by using the beta offset indicator field, and each index is determined according to the number of bits of HARQ-ACK information in the same manner as the method described above. By using the same method, sets of I_{offset}^{CSI-1} and I_{offset}^{CSI-2} may also be indicated.

TABLE 24

| | (I_{offset, 0}^{HARQ-ACK} or I_{offset, 1}^{HARQ-ACK} or |
|---|---|
| beta_offset | I_{offset, 2}^{HARQ-ACK}), (I_{offset, 0}^{CSI-1} or I_{offset, 0}^{CSI-2}), |
| indicator | (I_{offset, 1}^{CSI-1} or I_{offset, 1}^{CSI-2}) |
| ‘00’ | 1^{st} offset index provided by higher layers |
| ‘01’ | 2^{nd} offset index provided by higher layers |
| ‘10’ | 3^{rd} offset index provided by higher layers |
| ‘11’ | 4^{th} offset index provided by higher layers |

For HARQ-ACK transmission on an actual repetition of a PUSCH with repetition Type B with UL-SCH, the number of coded modulation symbols for each layer for HARQ-ACK transmission, denoted as Q′_{ACK}, is determined as follows:

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \} \qquad Equation 12 - A$$

where
   M_{sc,nominal}^{UCI} (l) is the number of resource elements that can be used for transmission of UCI in OFDM symbol l, for l=0, 1, 2, . . . , N_{symb,nominal}^{PUSCH}−1, in the PUSCH transmission assuming a nominal repetition without segmentation, and N_{symb,nominal}^{PUSCH} is the total number of OFDM symbols in a nominal repetition of the PUSCH, including all OFDM symbols used for DMRS;
   for any OFDM symbol that carries DMRS of the PUSCH assuming a nominal repetition without segmentation, M_{sc,nominal}^{UCI} (l)=0;
   for any OFDM symbol that does not carry DMRS of the PUSCH assuming a nominal repetition without segmentation, M_{sc,nominal}^{UCI} (l)=M_{sc}^{PUSCH}−M_{sc,nominal}^{PT-RS} (l) where M_{sc,nominal}^{PT-RS} (l) is the number of subcarriers in OFDM symbol l that carries PTRS, in the PUSCH transmission assuming a nominal repetition without segmentation;
   M_{sc,actual}^{UCI} (l) is the number of resource elements that can be used for transmission of UCI in OFDM symbol l, for l=0, 1, 2, . . . , N_{symb,actual}^{PUSCH}−1, in the actual repetition of the PUSCH transmission, and N_{symb,actual}^{PUSCH} is the total number of OFDM symbols in the actual repetition of the PUSCH transmission, including all OFDM symbols used for DMRS;
   for any OFDM symbol that carries DMRS of the actual repetition of the PUSCH transmission, M_{sc,actual}^{UCI} (l)=0;
   for any OFDM symbol that does not carry DMRS of the actual repetition of the PUSCH transmission, M_{sc,actual}^{UCI} (l)=M_{sc}^{PUSCH}−M_{sc,actual}^{PT-RS}(l) where M_{sc,actual}^{PT-RS} (l) is the number of subcarriers in OFDM symbol l that carries PTRS, in the actual repetition of the PUSCH transmission;
and all the other notations in the formula are defined the same as for PU SCH not using repetition type B.

On the other hand, in case that HARQ-ACK is transmitted to a PUSCH (or CG-PUSCH) and UL-SCH does not exist, the number of coded modulation symbols may be determined according to Equation 12-B below.

$${Q}_{ACK}^{′} = min \{ ⌈ \frac{( {O}_{A C K} + {L}_{A C K} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \} \qquad Equation 12 - B$$

Here, ‘R’ is a code rate of a PUSCH, which is a value configured by the base station, and is determined by higher layer signaling or L1 signaling. Additionally, Qm represents an order of the modulation scheme of a PUSCH.

Based on the Q′_{ACK} determined in Equation 12 and Equation 12-A above, E_{ACK}=N_{L}·Q′_{ACK}·Qₘ which is the number of coded word bits of ACK may be obtained.

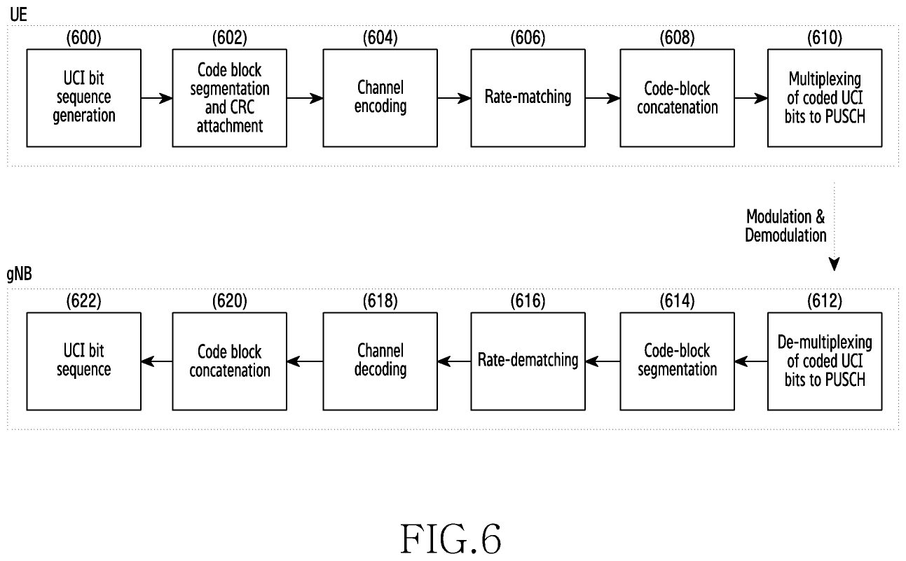

FIG. 6 illustrates a procedure of processing transmission and reception of UCI information to and from a PUSCH, the UCI information existing between a UE and a base station, according to an embodiment of the disclosure.

Referring to the procedure of FIG. 6, the UE generates UCI information in operation 600. In operation 602, the UE determines size of the UCI information and as a result of the determination, when the UCI information has a size of 11 bits or less, the UE does not include a CRC, and when the UCI information has a size greater than 12 bits, the UE additionally performs code block segmentation based on the UCI information size or includes a CRC. In operation 604, the UE performs channel coding of small block lengths when the UCI information has a size of 11 bits or less, and performs polarization coding when the UCI information has a size greater than 12 bits. In operation 606, the UE performs rate matching according to Equation 6 to Equation 12 depending on the UCI information type, so as to calculate the number of encoded modulation symbols. In operation 608, the UE performs code-block concatenation, and in operation 610, the UE performs multiplexing of encoded UCI bit information to a PUSCH. After the UE has transmitted the modulated PUSCH to the base station, the base station demodulates the PUSCH and performs demultiplexing of the encoded UCI bits to the PUSCH in operation 612. The base station performs segmentation of the received information in units of code blocks in operation 614 and performs rate de-matching in operation 616. In operation 618, the base station performs decoding using a channel coding scheme encoded according to the UCI information size. The base station performs concatenation of the decoded code blocks in operation 620 and obtains the UCI information. Through this series of procedures, the UCI information is included in the PUSCH and transmitted and received. The flow diagram described above in FIG. 6 is illustrative only, and it may be possible for at least one block of operations 600 to 622 to be omitted under specific conditions. Furthermore, it may be entirely possible that blocks other than those of operations 600 to 622 included in the flow diagram described above in FIG. 6 may be added and operated.

Next, Table 25 describes a procedure for multiplexing uplink data and control information.

TABLE 25
Step 1:
In case that HARQ-ACK information to be transmitted to a PUSCH has a size of 0,
1, or 2 bits, reserved resources for potential HARQ-ACK transmissions are
determined. The reserved resources are determined, in a frequency-first manner, from
a first symbol immediately after a symbol in which a first DMRS exists among
resources to which a PUSCH is allocated. The frequency-first scheme refers to a
scheme of sequentially mapping frequency resources for each symbol, and then
moving to a next symbol to perform mapping. Here, the amount of reserved resources
is calculated assuming that the HARQ-ACK information has a size of 2 bits.
Depending on whether PUSCH hopping is performed or not, the reserved resources
are used to determine whether the coded bits for potential HARQ-ACK transmission
are separated for each hop.
Step 2:
In case that the HARQ-ACK information to be transmitted to a PUSCH has a size
larger than 2 bits, rate matching is performed. In other words, the coded bits of
HARQ-ACK information may be mapped, in a frequency-first manner, from a first
symbol immediately after a symbol in which a first DMRS exists among resources to
which the PUSCH has been allocated.
Step 2A:
In case that there is CG-UCI information to be transmitted to a PUSCH, rate matching
is performed. In other words, the coded bits of the CG-UCI information are mapped,
in a frequency-first manner, from a first symbol immediately after a symbol in which
a first DMRS exists among resources to which the PUSCH is allocated.
Step 3:
In case that there is CSI part 1 information to be transmitted to a PUSCH, rate
matching is performed. CSI part 1 performs frequency-first mapping from a first
symbol immediately after excluding resources to which DMRS and HARQ-ACK
reserved, HARQ-ACK, or CG-UCI in steps 1, 2, or 2A have been allocated, among
resources to which a PUSCH has been allocated. Thereafter, CSI part 2 performs
frequency-first mapping from a first symbol excluding resources to which DMRS and
HARQ-ACK, CG-UCI, or CSI part 1 allocated in step 2 or 2A have been allocated,
among resources to which a PUSCH has been allocated. CSI part 2 may be allocated
to the reserved RE allocated in step 1 above.
Step 4:
Data information (UL-SCH) rate matching is performed. UL-SCH performs
frequency-first mapping to a resource to which a PUSCH has been allocated
excluding resources to which pieces of UCI information mapped in step 2 or 3 are
mapped. The UL-SCH may be allocated to the reserved RE allocated in step 1.
Step 5:
In case that HARQ-ACK information to be transmitted to a PUSCH has a size not
larger than 2 bits, mapping is performed to the resource reserved in step 1. At this
time, the amount of resources reserved is calculated assuming that HARQ-ACK is 2
bits, and thus the actual resources mapped may be smaller than the number of REs
reserved above. In case that there is a UCI resource or UL-SCH already mapped to
the resource in the steps 2 to 4, the information is punctured and the HARQ-ACK
information is mapped.
For the steps described above, in case that the number of bits of uplink control
information (or the number of modulated symbols) to be mapped to a PUSCH is
greater than the number of bits (or REs) which enable uplink control information
mapping in the corresponding OFDM symbol to be mapped, the frequency axis RE
interval d between modulated symbols of the uplink control information to be mapped
may be configured such that d = 1. In case that the number of bits of uplink control
information (or the number of modulated symbols) to be mapped to a PUSCH has a
size less than the number of bits (or REs) which enable uplink control information
mapping in the corresponding OFDM symbol to be mapped, the frequency axis RE
interval d between modulated symbols of the uplink control information to be mapped
may be configured such that d = floor(# of available bits on 1-OFDM symbol/# of
unmapped UCI bits at the beginning of 1-OFDM symbol).

### [PUCCH/PUSCH: Priority Level]

A transmission method of a UE according to priority information of a PUCCH and a PUSCH will be described below.

In case that one UE concurrently supports eMBB and URLLC, data or control information for eMBB may be transmitted to a PUSCH or PUCCH, and data or control information for URLLC may be transmitted to a PUSCH or PUCCH. Requirements for two services are different and generally URLLC service is prioritized over eMBB, and thus in case that at least one symbol among channels allocated with eMBB overlaps a channel allocated with URLLC, the UE may select at least one of URLLC or eMBB channel to perform transmission. More specifically, the priority information may be indicated by a higher layer signal or L1 signal and priority information value may be 0 or 1. The PUCCH or PUSCH indicated by 0 may be considered for eMBB and the PUCCH or PUSCH indicated by 1 may be considered for URLLC.

For a PUSCH, in case that there is a field capable of indicating priority information in DCI, the priority of the PUSCH may be determined by a value indicated by the field. Even if a PUSCH scheduled by DCI, in case that there is no field capable of indicating priority in DCI, the UE considers that the PUSCH has a priority value of 0. The PUSCH is applicable for both cases of including and not including aperiodic CSI or semi-persistent CSI. In a case of a configured grant PUSCH periodically transmitted or received without DCI, the priority is determined by a higher layer signal.

For a PUCCH, in case that the priority of a PUCCH for transmitting or receiving SR information and a PUCCH containing HARQ-ACK information on an SPS PDSCH may be determined by a higher-layer signal. In a case of a PUCCH containing HARQ-ACK information on a PDSCH scheduled by DCI, when there is a priority field in the corresponding DCI, a priority value indicated by the corresponding field is applied, and when there is no corresponding field, the priority is considered to have a value of 0. Other PUCCHs having semi-persistent CSI or periodic CSI are always considered to have a priority value of 0.

In case that resources of a PUSCH or PUCCH indicated by a higher layer signal or L1 signal, such as DCI overlap each other and priority information of PUCCHs is different from that of PUSCHs in at least a portion thereof, the UE may first resolve the overlapping between the PUCCH and PUSCH having a priority information value of 0. As an example, a series of processes of including UCI information included in a PUCCH in a PUSCH may be included. Thereafter, assuming that a resource of PUCCH or PUSCH finally determined through a PUCCH or PUSCH overlapping and having a low priority refers to a second PUCCH or second PUSCH and a PUCCH or PUSCH having higher priority refers to a first PUCCH or first PUSCH, the UE cancels the transmission of the second PUCCH and second PUSCH in case that the second PUCCH or second PUSCH overlap the first PUCCH or first PUSCH from the perspective of a time resource. The UE expects the transmission of the first PUCCH or first PUSCH to start at (T_{proc,2}+d₁) later, at least after the last symbol of PDCCH reception including DCI scheduling the corresponding transmission. Otherwise, the UE considers the same as an error case. The value of (T_{proc,2}+d₁) may use a value suggested by Equation 2.

According to the description above, the PUCCH containing HARQ-ACK information for a PDSCH containing eMBB data has a low priority value of 0, and the PUCCH containing HARQ-ACK information for a PDSCH containing URLLC data has a high priority value of 1. Therefore, in case that a PUCCH having a priority value of 0 overlap a PUCCH having a priority value of 1 from the perspective of a time resource, the UE is to drop the PUCCH having the priority value of 0 and transmit the PUCCH having the priority value of 1. Therefore, from the perspective of the base station, since HARQ-ACK information for a PDSCH containing eMBB data has not been received, it may not be known whether the UE has received the eMBB data properly, and thus the base station has no alternative but to retransmit. Accordingly, there is a possibility of deterioration of eMBB data transmission and reception efficiency.

For convenience of explanation, HARQ-ACK information for a PDSCH containing eMBB data is referred to as low priority (LP) HARQ-ACK, and HARQ-ACK information for a PDSCH containing URLLC data is referred to as high priority (HP) HARQ-ACK. Low priority (LP) HARQ-ACK may indicate HARQ-ACK information having a priority value of 0 and high priority (HP) HARQ-ACK may indicate HARQ-ACK information having a priority value of 1.

As an available method for preventing deterioration of eMBB data transmission and reception efficiency, there may be a method in which HP HARQ-ACK and LP HARQ-ACK are simultaneously multiplexed in one PUCCH or PUSCH. Accordingly, in case that HP HARQ-ACK and LP HARQ-ACK are multiplexed to a PUCCH or PUSCH, there is a possibility that they will be multiplexed along with the existing CSI part 1 and CSI part 2. In case that the base station or the UE is able to multiplex a PUCCH or PUSCH by multiplexing only a maximum of three pieces of UCI information, a method may be required to determine which of the four pieces of information to drop and to select the remainder.

Hereinafter, in an embodiment, a method for multiplexing UCI information in a PUSCH in an environment where HP HARQ-ACK and LP HARQ-ACK exist is described. In addition, since the HP HARQ-ACK and LP HARQ-ACK have different requirements even if they are the same HARQ-ACK information, there may be a need for the HP HARQ-ACK to be transmitted more reliably than the LP HARQ-ACK, and accordingly different encoding and rate matching methods may be applied. As an example, in case that the number of coded modulation symbols for HP HARQ-ACK and LP HARQ-ACK is determined in Equation 12, different values may be applied for at least β_{offset}^{PUSCH} or α value. In addition, in case that HP HARQ-ACK and LP HARQ-ACK are multiplexed in one PUSCH, Equation 9 is adopted for HP HARQ-ACK while the number (Q′_{LP_ACK}) of coded modulation symbols may be determined by Equation 13-A when LP HARQ-ACK is transmitted to a PUSCH (or CG-PUSCH.

$${Q}_{LP \_ ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ - {Q}_{ACK / CG - UCI}^{′} \} \qquad Equation 13 - A$$

For HARQ-ACK LP transmission on an actual repetition of a PUSCH with repetition Type B with UL-SCH, the number of coded modulation symbols for each layer for HARQ-ACK LP transmission, denoted as Q′_{ACK} is determined as follows:

$${Q}_{ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , actual}^{PUSCH} - 1} {M}_{sc , actual}^{UCI} ( l ) - {Q}_{ACK / CG - UCI}^{′} \}$$

In addition, in case that there is CSI part 1 with no UL-SCH, the number (Q′_{LP_ACK}) of coded modulation symbols may be determined by Equation 13-B below.

$${Q}_{LP \_ ACK}^{′} = min \{ ⌈ \frac{( {O}_{LP \_ ACK} + {L}_{LP \_ ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ - {Q}_{ACK / CG - UCI}^{′} \} \qquad Equation 13 - B$$

In addition, in case that there is CSI part 1 with no UL-SCH, the number (Q′_{LP_ACK}) of coded modulation symbols may be determined by Equation 13-C below.

$${Q}_{LP \_ ACK}^{′} = {\sum }_{l = {l}_{0}}^{{N}_{symb , all}^{PUSCH} - 1} {M}_{sc}^{UCI} ( l ) - {Q}_{ACK / CG - UCI}^{′} \qquad Equation 13 - C$$

The above Q′_{ACK/CG-UCI} is a value determined based on Equation 12, Equation 12-A, or Equation 12-B and denotes the number of coded modulation symbols for each layer for HARQ_ACK, CG-UCI, or HARQ_ACK/CG-UCI transmission.

### [PUCCH: Type 1 HARQ-ACK Codebook]

The following describes a semi-static HARQ-ACK codebook (or Type-1 HARQ-ACK codebook).

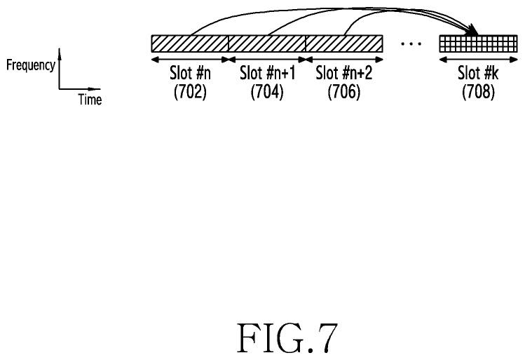

FIG. 7 illustrates a method for configuring a semi-static HARQ-ACK codebook (or Type-1 HARQ-ACK codebook) in an NR system according to an embodiment of the disclosure.

In a situation in which the number of HARQ-ACK PUCCHs which the UE is able to transmit in one slot is limited to one, when a semi-static HARQ-ACK codebook higher-layer signaling configuration is received by the UE, the UE receives a PDSCH in an HARQ-ACK codebook in a slot indicated by the value of a PDSCH-to-HARQ feedback timing indicator in DCI format 1_x, or report HARQ-ACK information for SPS PDSCH release in the slot. The UE reports an HARQ-ACK information bit value, as a NACK, in an HARQ-ACK codebook in a slot that is not indicated by a PDSCH-to-HARQ feedback timing indicator field in a DCI format 1_x. If the UE reports only HARQ-ACK information for one SPS PDSCH release or one PDSCH reception in MA,c cases for candidate PDSCH reception, and the report is scheduled by a DCI format 1_0 including information indicating that a counter DCI field is 1 in a PCell, the UE determines one HARQ-ACK codebook for the SPS PDSCH release or the PDSCH reception.

Other than the above case, an HARQ-ACK codebook determination method according to the methods described below is followed.

When a set of PDSCH reception candidate occasions in serving cell c is MA,c, MA,c may be obtained through the [pseudo-code 1] steps below.

### [Pseudo-Code 1 Start]

Step 1: initializing j to 0, and initializing MA,c to an empty set. Initializing k, which is an HARQ-ACK transmission timing index, to 0.

Step 2: configuring R as a set of rows of a table including information of a slot to which a PDSCH is mapped, starting symbol information, and information of the number or length of symbols. When a PDSCH-available mapping symbol indicated by a value of R is configured to a UL symbol according to DL and UL configurations configured through higher layer signaling, removing a corresponding row from R.

Step 3-1: receiving, by a UE, one unicast PDSCH in one slot, and when R is not an empty set, adding one PDSCH to set MA,c.

Step 3-2: if the UE is able to receive two or more unicast PDSCHs in one slot, counting the number of PDSCHs allocatable in different symbols from the calculated R, and adding the counted number of PDSCHs to MA,c.

Step 4: increasing k by one and restarting from step 2.

### [Pseudo-Code 1 End]

In pseudo-code 1, as illustrated in FIG. 7, in order to transmit an HARQ-ACK PUCCH in slot #k 708, all slot candidates in which a PDSCH-to-HARQ-ACK timing which can indicate slot #k 708 is possible are considered. In FIG. 7, it is assumed that HARQ-ACK transmission is possible in slot #k 708 by a combination of PDSCH-to-HARQ-ACK timings that are possible by only PDSCHs scheduled in slot #n 702, slot #(n+1) 704, and slot #(n+2) 706. In based on time domain resource configuration information of a PDSCH which can be scheduled in each of the slots 702, 704, and 706, and information indicating whether a symbol in a slot corresponds to the uplink or the downlink, the number of PDSCHs which can be maximally scheduled for each slot is derived. For example, in case that two PDSCHs can be maximally scheduled in the slot #n 702, three PDSCHs can be maximally scheduled in the slot #(n+1) 704, and two PDSCHs can be maximally scheduled in the slot #(n+2) 706, the maximum number of PDSCHs included in an HARQ-ACK codebook transmitted in the slot #k 708 is 7. This is called the cardinality of an HARQ-ACK codebook.

### [PUCCH: Type 2 HARQ-ACK Codebook]

The following describes a dynamic HARQ-ACK codebook (or Type-2 HARQ-ACK codebook).

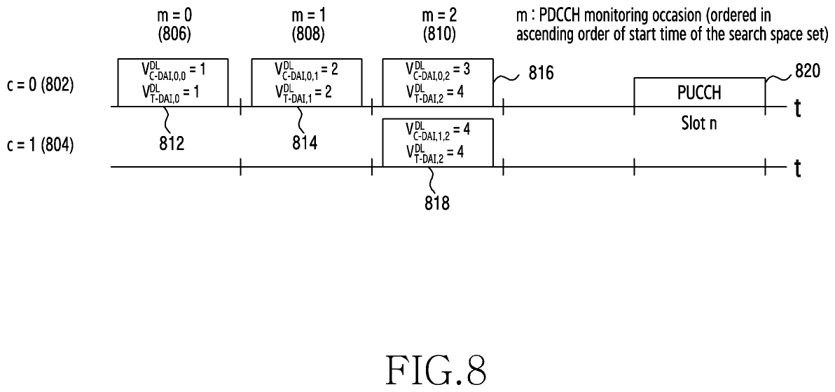

FIG. 8 illustrates a method for configuring a dynamic HARQ-ACK codebook (or Type-2 HARQ-ACK codebook) in an NR system according to an embodiment of the disclosure.

A UE transmits HARQ-ACK information transmitted in one PUCCH in slot n, based on a PDSCH-to-HARQ feedback timing value for PUCCH transmission of HARQ-ACK information in slot n for PDSCH reception or SPS PDSCH release, and a K0 that is transmission slot position information of a PDSCH scheduled by DCI format 1_x. Specifically, for the above HARQ-ACK information transmission, the UE determines an HARQ-ACK codebook of a PUCCH transmitted in a slot determined by a PDSCH-to-HARQ feedback timing and K0, based on a downlink assignment index (DAI) included in DCI indicating a PDSCH or SPS PDSCH release.

The DAI is configured by a counter DAI and a total DAI. The counter DAI is information indicating the position of HARQ-ACK information in a HARQ-ACK codebook, the HARQ-ACK information corresponding to a PDSCH scheduled by DCI format 1_x. Specifically, a counter DAI value in a DCI format 1_0 or 1_1 indicates the accumulative value of PDSCH receptions or SPS PDSCH releases scheduled by the DCI format 1_x in a specific cell c. The above accumulative value is configured based on a PDCCH monitoring occasion in which the scheduled DCI exists and a serving cell.

The total DAI is a value indicating the size of an HARQ-ACK codebook. Specifically, a total DAI value implies the total number of PDSCHs or SPS PDSCH releases which are scheduled at and before the time point at which DCI is scheduled. A total DAI is a parameter used in a case in which, in a carrier aggregation (CA) situation, HARQ-ACK information in serving cell c also includes HARQ-ACK information for a PDSCH scheduled in another cell including serving cell c. In other words, there is no total DAI parameter in a system operated by one cell.

An example of operation relating to the DAI is illustrated in FIG. 8.

FIG. 8 shows that, in a situation in which two carriers are configured for a UE, when the UE transmits an HARQ-ACK codebook selected based on a DAI, to a PUCCH 820, in an n-th slot of carrier 0 802, the values of a counter DAI (C-DAI) and a total DAI (T-DAI) indicated by DCI discovered in each PDCCH monitoring occasion configured for each carrier are changed. First, in DCI discovered in an occasion (m=0) 806, each of the C-DAI and the T-DAI indicates a value of 1 (indicated by reference numeral 812). In DCI discovered in an occasion (m=1) 808, each of the C-DAI and the T-DAI indicates a value of 2 (indicated by reference numeral 814). In DCI discovered in an occasion (m=2) 810 in carrier 0 (c=0) 802, the C-DAI indicates a value of 3 (indicated by reference numeral 816). In DCI discovered in an occasion (m=2) 810 in carrier 1 (c=1) 804, the C-DAI indicates a value of 4 (indicated by reference numeral 818). If carriers 0 and 1 are scheduled in the same monitoring occasion, all the T-DAIs are indicated by 4.

In FIGS. 7 and 8, the determination of an HARQ-ACK codebook is operated in a situation in which only one PUCCH containing HARQ-ACK information is transmitted in one slot. This operation is called mode 1. As an example of a method in which one PUCCH transmission resource is determined in one slot, when PDSCHs scheduled in different pieces of DCI are multiplexed into one HARQ-ACK codebook in the same slot, and the codebook is transmitted, a PUCCH resource selected for HARQ-ACK transmission is determined to be a PUCCH resource indicated by a PUCCH resource field indicated in DCI lastly scheduling a PDSCH. For example, a PUCCH resource indicated by a PUCCH resource field indicated in DCI scheduled before the DCI is ignored.

In the following description, HARQ-ACK codebook determination methods and apparatuses are defined in a situation in which two or more PUCCHs containing HARQ-ACK information can be transmitted in one slot. This operation is called mode 2. A UE can operate only in mode 1 (transmission of only one HARQ-ACK PUCCH in one slot) or operate only in mode 2 (transmission of one or more HARQ-ACK PUCCHs in one slot). Alternatively, in a case of a UE supporting both mode 1 and mode 2, it may be possible that a base station configures the UE to be operated in only one mode by higher layer signaling, or mode 1 and mode 2 are implicitly configured by a DCI format, an RNTI, a particular field value of DCI, scrambling, and the like. For example, a PDSCH scheduled by a DCI format A, and pieces of HARQ-ACK information associated with the PDSCH are based on mode 1, and a PDSCH scheduled by a DCI format B, and pieces of HARQ-ACK information associated with the PDSCH are based on mode 2.

### [PUCCH: Type 3 HARQ-ACK Codebook]

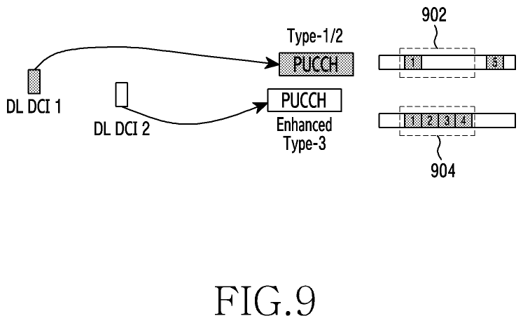

FIG. 9 illustrates a situation in which a plurality of different HARQ-ACK codebooks are overlapped according to an embodiment of the disclosure.

The following describes a Type-3 HARQ-ACK codebook.

Unlike the Type-1 and Type-2 HARQ-ACK codebooks, the Type-3 HARQ-ACK codebook is a scheme for reporting all pieces of HARQ-ACK information with respect to all serving cells, the number of HARQ processes, the number of TBs for each HARQ process, and the number of CBGs for each transport block (TB), the configurations of which have been received by the UE. For example, in case that there are two serving cells, 16 HARQ processes for each serving cell, one TB for each HARQ process, and two CBGs for each TB, the UE reports a total of 64 (=2×16×1×2) bits of HARQ-ACK information. In addition, depending on a separate configuration, it may be possible to report the HARQ-ACK information and a new data indicator (NDI) value recently received by the UE for each HARQ process associated with the HARQ-ACK information. The NDI value allows the base station to determine whether a PDSCH received by the UE for each HARQ process is determined to be an initial transmission or a retransmission. In case that the corresponding NDI value is not reported, if the UE has already reported HARQ-ACK information for a specific HARQ process before the base station receives the DCI requesting the Type-3 HARQ-ACK codebook, the UE maps NACK to the HARQ process, otherwise, the UE maps HARQ-ACK information bits to the PDSCH received for each HARQ process. The number of serving cells, the number of HARQ processes, the number of TBs, and the number of CBGs are each configurable, and when there is no separate configuration, the UE may consider that the number of serving cells is 1, the number of HARQ processes is 8, the number of TBs is 1, and the number of CBGs is 1, respectively. Further, the number of HARQ processes may be different for each serving cell. Further, the number of TBs may have different values for each serving cell or for each BWP within a serving cell. Further, the number of CBGs may be different for each serving cell.

One of the reasons why a Type-3 HARQ-ACK codebook is required is that a UE may not be able to transmit a PUCCH or PUSCH containing HARQ-ACK information for a PDSCH due to channel access failure or overlap with other channels with higher priority. Therefore, it is reasonable for the base station to request only the corresponding HARQ-ACK information to be reported because there is no need to reschedule a separate PDSCH. Therefore, it may be possible for the base station to schedule the above Type-3 HARQ-ACK codebook and the PUCCH resources containing the corresponding codebook via a higher layer signal or L1 signal (e.g., a specific field in the DCI).

In case that the UE detects a DCI format that includes a value of 1 in afield in which a one-shot HARQ-ACK request is made, the UE determines a PUCCH or PUSCH resource to multiplex the Type-3 HARQ-ACK codebook in a specific slot indicated by the DCI format. In addition, the UE multiplexes only the Type-3 HARQ-ACK codebook within the PUCCH or PUSCH for transmission in that slot. In other words, in case that two PUCCHs are overlapped, one of which is a Type-1 HARQ-ACK codebook (or Type-2 HARQ-ACK codebook) and the other is a Type-3 HARQ-ACK codebook, the UE multiplexes only the Type-3 HARQ-ACK codebook to the PUCCH or PUSCH. The reason is that the Type-3 HARQ-ACK codebook includes the HARQ-ACK information bits for all serving cells, all HARQ process numbers, all TBs, and all CBGs, the configurations of which have been received by the UE, and thus it may be considered that the information of the Type-1 HARQ-ACK codebook and the Type-2 HARQ-ACK codebook is already included in the Type-3 HARQ-ACK codebook.

However, since the Type-3 HARQ-ACK codebook includes all the HARQ-ACK information bits based on all the pieces of information, the configuration which have been received by the UE, the HARQ-ACK information bits for a PDSCH which is not actually scheduled should also be included in the codebook even if they are mapped as NACK, and thus there is a disadvantage in that the information bit size is large. Therefore, as the uplink control information bit size increases, there is a possibility that the uplink transmission coverage or transmission reliability may be reduced. Therefore, there is a need for a HARQ-ACK codebook with a smaller size than a Type-3 HARQ-ACK codebook. In the disclosure, this is considered as different from the existing Type-3 HARQ codebook, and for convenience, it is described in this disclosure as an enhanced Type-3 HARQ-ACK codebook (or Type-4 HARQ-ACK codebook). However, it is quite possible to replace this by other names. For example, the enhanced Type-3 HARQ-ACK codebook may be organized as follows.
Type A: a subset of a total set of (configured) serving cells
Type B: a subset of a total set of (configured) HARQ process numbers
Type C: s subset of a total set of (configured) TB indices
Type D: a subset of a total set of (configured) CBG indices
Type E: a combination of at least two types among the above types A to D

It is possible for the enhanced Type-3 HARQ-ACK codebook to have the characteristics of at least one of the above types A to E, and to include one or multiple sets. The enhanced Type-3 HARQ-ACK codebook may include a universal set instead of a subset of the above types A to E. The plurality of sets has a meaning such that it is possible for type A and type B to exist, or for type A to have different subsets. In based on Types A to E above, the enhanced Type-3 HARQ-ACK codebook may be indicated by a higher layer signal or L1 signal or a combination thereof. For example, it may be possible for the higher layer signal to indicate a set configuration for the HARQ-ACK information bits to be reported to each enhanced Type-3 HARQ-ACK codebook as shown in the following Table 26, and one value of this is indicated by the L1 signal. It may be possible for the higher layer signal to individually configure which type of enhanced Type-3 HARQ-ACK codebook is configured for each index, as shown in Table 26. It is also possible that the type-3 HARQ-ACK codebook that reports all HARQ-ACK information bits is used for a particular index, such as index 3. The type-3 HARQ-ACK codebook may be, in case that it is indicated by a separate higher layer signal or in the absence of a higher layer signal, determined to be used as a default value (e.g., ACK or NACK state for all HARQ process numbers).

TABLE 26

| Index | Type 3 |
|---|---|
| 1 | Serving cell i, HARQ process number (#1~#8), TB 1 |
| 2 | Serving cell i, HARQ process number (#9~#12), TB 1 |
| 3 | Type-3 HARQ-ACK codebook |
| . . . | . . . |

In case that the UE receives a value requesting the one-shot HARQ-ACK feedback field, and receives a value indicated by index 1 according to Table 26, the UE reports a total of 8 bits of HARQ-ACK information bits for serving cell i, HARQ process number (#1 to #8), and TB 1. In case that the UE receives a value requesting the one-shot HARQ-ACK feedback field and is to receive a value indicated by index 2 according to Table 26, the UE reports a total of 4 bits of HARQ-ACK information bits for serving cell i, HARQ process number (#1 to #8), and TB 1. In case that the UE receives a value requesting the one-shot HARQ-ACK feedback field and is to receive a value indicated by index 3 according to Table 26, the UE calculates the total number of HARQ-ACK bits by considering the set of serving cells, the total number of HARQ processes for each serving cell i, the number of TBs for each HARQ process, and the number of CBGs for each TB. The above Table 26 is an example only, the total number of indices may be greater or smaller than those listed in this table, and the range of HARQ process values indicated by each index and/or the information included in the enhanced Type-3 HARQ-ACK codebook may differ. In addition, the information in Table 26 above may be indicated by a higher layer signal, and specific indices may be notified of via DCI. It is also possible that pieces of HARQ-ACK information indicated by specific index values other than those listed in the above Table 26 or indicated via the one-shot HARQ-ACK feedback field (or other L1 signal) may be used, in case that pieces of specific HARQ-ACK information previously scheduled and intended to be transmitted by the UE are dropped, for the purpose of retransmitting the pieces of specific HARQ-ACK information, instead of the HARQ-ACK information for a specific (or all) HARQ process numbers. This is referred to as dropped HARQ-ACK retransmission. The drop of the specific HARQ-ACK information may be possible in case that another PUCCH or PUSCH that has a higher priority than the PUCCH or PUSCH containing the HARQ-ACK information is overlapped. Alternatively, the drop of the specific HARQ-ACK information may be possible in case that at least one of the symbols in the PUCCH or PUSCH containing the HARQ-ACK information has been previously indicated as a downlink symbol by a higher layer signal. Alternatively, the drop of the specific HARQ-ACK information may be possible in case that the PUCCH or PUSCH containing the HARQ-ACK information is at least partially overlapped with resources indicated by the DCI, including uplink cancellation information, which has the purpose of canceling the uplink transmission. In case that the UE supports both the dropped HARQ-ACK retransmission and the (enhanced) type-3 HARQ codebook based transmission described above, the UE is able to report the HARQ information by selecting at least one of the dropped HARQ-ACK retransmission and the (enhanced) type-3 HARQ codebook-based transmission by means of RNTI information scrambled with a CRC of DCI, the type of search space in which the DCI has been searched for, or the priority information of the DCI fields, or information on at least one of the MCS, redundancy version (RV), NDI, HARQ process ID, or any combination thereof. Alternatively, specific index values in Table 26 may be configured and used for dropped HARQ-ACK retransmissions. The selection of a specific index in Table 26 may be indicated by at least one of the HARQ process number in the DCI field, the MCS or NDI or RV or frequency resource allocation information, time resource allocation information, or a combination thereof. The size of the DCI bit field indicating a specific index in Table 26 above may be determined by ┌log₂(Nₜₒₜₐₗ^{index}) ┐. Here, Nₜₒₜₐₗ^{index} implies a total number of indices of Table 26 configured by a high layer signal.

The total number of HARQ-ACK bits, N, may be expressed as Equation 14

$$N = {\sum }_{c}^{n ( c )} {H}_{c} \times {T}_{b , c} \times {B}_{c} \qquad Equation 14$$

In Equation 14, n(c) is the total number of serving cells c, H_{c} is the number of HARQ processes configured in serving cell c, T_{b,c} is the number of TBs for each HARQ process configured in serving cell c and the BWP b, and B_{c} is the number of CBGs configured in serving cell c. In addition, when the UE detects a DCI format with a one-shot HARQ-ACK request field value of 1, the UE determines a PUCCH or PUSCH resource to multiplex the corresponding Type-3 HARQ-ACK codebook (or enhanced Type-3 HARQ-ACK codebook). The UE multiplexes only the Type-3 HARQ-ACK codebook (or enhanced Type-3 HARQ-ACK codebook) to the determined PUCCH or PUSCH resource for transmission in the corresponding slot. In case that there is a PUCCH or PUSCH containing CSI information or SR information that overlaps with the PUCCH or PUSCH resource, the UE is able to drop the SR or CSI information without multiplexing the same. In other words, the UE is able to multiplex only the Type-3 HARQ-ACK information and drop the SR and CSI, which are different UCIs.

As described above, since the Type-3 HARQ-ACK codebook includes HARQ-ACK information for all HARQ process numbers, the configuration of which has been received by the UE, when a PUCCH or PUSCH containing a Type-3 HARQ-ACK codebook overlaps with a PUCCH or PUSCH containing information about another HARQ-ACK (e.g., a Type-1 or Type-2 HARQ-ACK codebook), it is not necessary to multiplex each of the overlapping HARQ-ACK codebooks because the Type-3 HARQ-ACK codebook already includes all the pieces of HARQ-ACK information. Therefore, it may be reasonable for the UE to transmit only the PUCCH or PUSCH containing the Type-3 HARQ-ACK codebook and drop the other HARQ-ACK codebooks that are scheduled to overlap. However, in case that an enhanced Type-3 HARQ-ACK codebook containing HARQ-ACK information for some HARQ process numbers that is not a Type-3 HARQ-ACK codebook is overlapped with a PUCCH or PUSCH containing HARQ-ACK information different from the enhanced Type-3 HARQ-ACK codebook, various multiplexing methods may be considered. An example of such a multiplexing method is shown in FIG. 9. FIG. 9 illustrates a situation in which a plurality of different HARQ-ACK codebooks are overlapped according to an embodiment. The situation is such that a PUCCH containing Type 1 or Type 2 HARQ-ACK information is scheduled by DL DCI 1, and a PUCCH containing enhanced Type-3 HARQ-ACK information is scheduled by DL DCI 2, and the two PUCCHs are overlapped from a time resource perspective. In this case, the PUCCH containing Type 1 or Type 2 HARQ-ACK information is referred to as a first PUCCH, and the PUCCH containing enhanced Type-3 HARQ-ACK information is referred to as a second PUCCH. The first PUCCH 902 includes HARQ-ACK information for HARQ process numbers 1 and 5, and the second PUCCH 904 includes HARQ-ACK information for HARQ process numbers 1, 2, 3, and 4. In case that the UE transmits only the second PUCCH and drops the first PUCCH, the base station is unable to receive HARQ-ACK information for HARQ process number 5 because the HARQ-ACK information for HARQ process number 1 is also included in the second PUCCH, but the HARQ-ACK information for HARQ process number 5 is not included in the second PUCCH. Therefore, there is a need for the UE to multiplex the HARQ information contained in the first and second PUCCHs.

### [PUCCH Power Control]

PUCCH power control is described below. The following Equation 12 is an equation of determining the PUCCH transmission power.

$${P}_{PUCCH , b , f , c} ( i , {q}_{u} , {q}_{d} , l ) = min \{ \begin{matrix}{P}_{CMAX , f , c} ( i ) , \\ {P}_{{0}_{PUCCH} , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{{F}_{PUCCH}} ( i ) + \\ {Δ}_{TF , b , f , c} ( i ) + {f}_{b , f , c} ( i , l )\end{matrix} \} [ dBm ] \qquad Equation 15$$

In Equation 15, P₀_{_{PUCCH}}_{,b,f,c}(qᵤ) is a reference configuration transmission power configuration value, and may have different values according to various transmission types qᵤ and be changed by a higher layer signal, such as RRC or an MAC CE. When the value is changed by the MAC CE and a slot for transmitting HARQ-ACK is k for a PDSCH receiving the MAC CE, the UE determines that the corresponding value is applied starting at a slot (k+k_{offset}). K_{offset} may have different values according to subcarrier spacing and have, for example, 3 ms. M_{RB,b,f,c}^{PUCCH}(i) denotes the size of a frequency resource area to which the PUCCH is allocated. PL_{b,f,c}(q_{d}) denotes a path attenuation estimation value of the UE and is calculated by the UE base on a specific reference signal among various CSI-RSs or SS/PBCHs according to whether a higher-layer signal is configured and according to the type thereof. The same q_{d} is applied to repeated transmission PUCCHs. The same qᵤ is applied to repeated transmission PUCCHs.

For PUCCH formats 2, 3, and 4, in case that the UCI has a size greater than or equal to 11, the value of Δ_{TF,b,f,c}(i) of Equation 15 is determined by the following Equation 16.

$${Δ}_{TF , b , f , c} ( i ) = 10 {log}_{10} ( {K}_{1} \cdot ( {n}_{HARQ - ACK} ( i ) + {O}_{SR} ( i ) + {O}_{CSI} ( i ) ) / {N}_{RE} ( i ) ) \qquad Equation 16$$

In Equation 16, K₁ is 6, n_{HARQ-ACK}(i) denotes the number of HARQ-ACK bits, O_{SR}(i) denotes the number of SR bits, O_{CSI}(i) denotes the number of CSI bits, and N_{RE} (i) denotes the number of REs of the PUCCH.

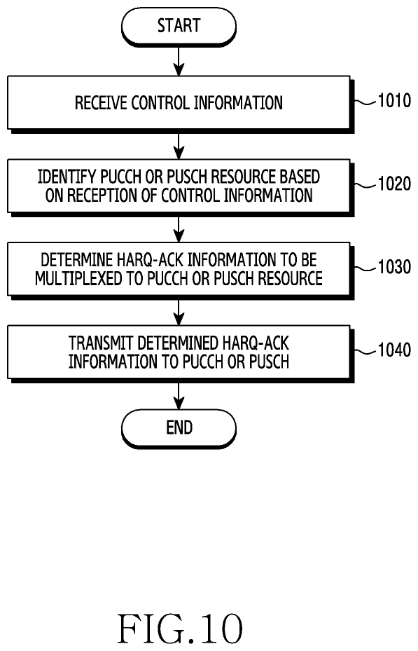

FIG. 10 is a block diagram illustrating a PUCCH or PUSCH transmission operation of a UE according to an embodiment of the disclosure.

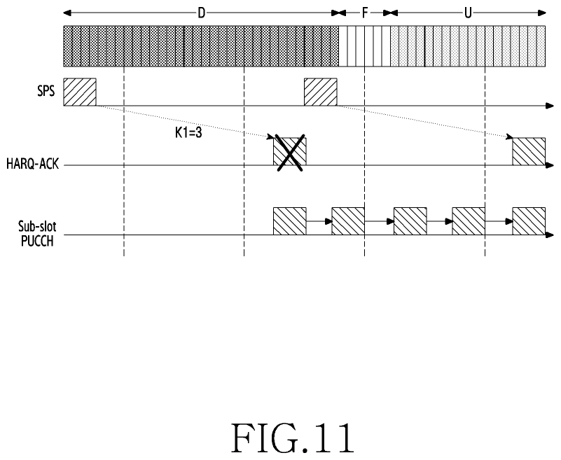

FIG. 11 illustrates a relationship between an SPS PDSCH and transmission of HARQ-ACK information thereto according to an embodiment of the disclosure.

Referring to FIGS. 10 and 11, the UE receives control information from a base station in operation 1010. The control information may correspond to a higher layer signal or an L1 signal, and one or multiple pieces of control information may exist. In addition, the UE determines a PUCCH or PUSCH resource based on the control information in operation 1020. Furthermore, the UE determines the HARQ-ACK or other pieces of UCI information to be multiplexed to each PUCCH or PUSCH resource in operation 1030. In addition, in case that two or more PUCCH or PUSCH resources are overlapped or that there are two or more PUCCHs or PUSCHs containing HARQ-ACK information in at least one slot or sub-slot, the UE determines whether to multiplex the HARQ-ACK. Thereafter, based on the above methods, the UE finally determines a PUCCH or PUSCH to transmit the HARQ-ACK information or other UCI information and determines the transmission power therefor in operation 1040.

### [PDSCH: SPS]

The following describes an SPS operation. In case that a UE is able to operate two or more activated DL SPS in one cell/one BWP, the base station may provide two or more DL SPS configurations to a UE. The reason for supporting two or more DL SPS configurations is that when a UE supports various traffics, different MCSs or time/frequency resource allocation or period may be different for each traffic, and thus it would be advantageous to configure the DL SPS for each usage.

The UE may receive at least some of the higher-layer signaling configuration information for the DL SPS as shown in Table 27.

TABLE 27
- Periodicity: DL SPS transmission period
- nrofHARQ-Processes: Number of HARQ processes configured for
DL SPS
- n1PUCCH-AN: HARQ resource configuration information for DL SPS
- mcs-Table: MCS table configuration information applied to DL SPS
- sps-ConfigIndex-r16: Index of SPS configured in one cell/one BWP
- harq-ProcID-Offset-r16: Offset value for calculating HARQ-ACK
process number
- periodicityExt-r16: DL SPS transmission period, it can be configured
to be different values according to a subcarrier spacing and when the
corresponding field exists, periodicity is ignored
- harq-CodebookID-r16: HARQ-ACK codebook index information for
SPS or SPS release
- pdsch-AggregationFactor-r16: Number of SPS PDSCH repeated
transmissions

The SPS index among the higher-layer signaling configuration information may be utilized for the purpose of indicating which SPS the DCI (L1 signaling) providing SPS activation or deactivation indicates. Specifically, in a situation in which two SPSs are configured as the higher layer signal in one cell or/and one BWP, in order for the UE to know which of the two DCIs indicating the activation of the SPS indicates the activation of the SPS, SPS index information that informs the SPS higher information may be required. As an example, the HARQ process number field in the DCI indicating SPS activation or deactivation indicates the index of a specific SPS, and the UE may perform activation or deactivation of the SPS indicated through the HARQ process number field. Specifically, as shown in Table 28, when the DCI including the CRC scrambled with the CG-RNTI includes the following information and new data indicator (NDI) field of the DCI indicates 0, the UE may determine that the DCI indicates a specific pre-activated SPS PDSCH release (deactivation) indicated by the HARQ process number field.

TABLE 28

| | DCI format 0_0 | DCI format 1_0 |
|---|---|---|
| HARQ process number | SPS index | SPS index |
| Redundancy version | set to ‘00’ | set to ‘00’ |
| Modulation and coding scheme | set to all ‘1’s | set to all ‘1’s |
| Frequency domain resource | set to all ‘1’s | set to all ‘1’s |
| assignment | | |

In Table 28, one HARQ process number may indicate one SPS index or it may be possible to indicate a plurality of SPS indices. In addition to the HARQ process number field, one or a plurality of SPS index(s) may be indicated by other DCI fields (time resource field, frequency resource field, MCS, RV, PDSCH-to-HARQ timing field, or the like). Basically, one SPS may be activated or deactivated by one DCI. The position of the type 1 HARQ-ACK codebook for HARQ-ACK information for DCI indicating SPS PDSCH release is the same as the position of the type 1 HARQ-ACK codebook corresponding to the reception position of the corresponding SPS PDSCH. In case that the position of the HARQ-ACK codebook corresponding to the candidate SPS PDSCH reception in a slot is k1, the position of the HARQ-ACK codebook for the DCI indicating the release of the corresponding SPS PDSCH is also k1. Therefore, when DCI indicating SPS PDSCH release is transmitted in the slot k, the UE does not expect to receive the PDSCH corresponding to the HARQ-ACK codebook position k1 in the same slot k, and when this situation occurs, the UE regards the same as an error case. Although the above Table 28 uses DCI formats 0_0 and 1_0 as an example, it can also be applied to DCI formats 0_1 and 1_1, and can be extended and applied to other DCI formats 0_x and 1_x. By the above-described operation, the UE receives the DCI indicating reception of the SPS PDSCH higher layer signal and the activation of the SPS PDSCH, so that one or more SPS PDSCHs are simultaneously operated in one cell or/and one BWP. Thereafter, the UE periodically receives the activated SPS PDSCH in one cell or/and one BWP and transmits HARQ-ACK information corresponding thereto. The UE determines the HARQ-ACK information corresponding to the SPS PDSCH through slot interval information by the PDSCH-to-HARQ-ACK feedback timing included in the activated DCI information, accurate time and frequency information in the corresponding slot through n1PUCCH-AN information included in the SPS higher-layer configuration information, and PUCCH format information. When the PDSCH-to-HARQ-ACK feedback timing field included in the DCI information does not exist, the UE assumes one value previously configured as the higher layer signal as a default value and determines that the corresponding value is applied.

Alternatively, the UE may configure the next DL SPS configuration information from the higher layer signal.
Periodicity: DL SPS transmission period
nrofHARQ-Processes: number of HARQ processes configured for DL SPS
n1PUCCH-AN: HARQ resource configuration information for DL SPS
mcs-Table: MCS table configuration information applied to DL SPS

In the disclosure, all DL SPS configuration information can be configured for each PCell or SCell, and can also be configured for each frequency bandwidth part (BWP). In addition, it may be possible to configure one or more DL SPSs for each BWP for each specific cell.

The UE determines grant-free transmission/reception configuration information through reception of a higher layer signal for the DL SPS. The DL SPS may be able to transmit/receive data to/from a configured resource region after receiving DCI indicating activation, and may be unable to transmit/receive data to/from a resource region before receiving the DCI. In addition, the UE may be unable to perform data reception for the resource region after receiving DCI indicating release.

The UE verifies a DL SPS assignment PDCCH when both of the following two conditions are satisfied for SPS scheduling activation or release.
Condition 1: a case in which a CRC bit of a DCI format transmitted in the PDCCH is scrambled by CS-RNTI configured by higher layer signaling.
Condition 2: a case in which a new data indicator (NDI) field for activated transport block is configured as 0

In case that some of fields constituting the DCI format transmitted to the DL SPS assignment PDCCH are the same as those shown in Table 29 or Table 30, the UE determines that information in the DCI format is valid activation or effective release of the DL SPS. For example, when the UE detects the DCI format including the information shown in Table 29, the UE determines that the DL SPS is activated. As another example, when the UE detects the DCI format including information shown in Table 30, the UE determines that the DL SPS is released.

In case that some of fields constituting the DCI format transmitted to the DL SPS assignment PDCCH are not the same as those suggested in Table 29 (special field configuration information for activating DL SPS) or Table 30 (special field configuration information for releasing DL SPS), the UE determines that the DCI format is detected as a mismatched CRC.

TABLE 29

| | DCI format 1_0 | DCI format 1_1 |
|---|---|---|
| HARQ process number | set to all ‘0’s | set to all ‘0’s |
| Redundancy version | set to ‘00’ | For the enabled transport |
| | | block: set to ‘00’ |

TABLE 30

| | DCI format 1_0 |
|---|---|
| HARQ process number | set to all ‘0’s |
| Redundancy version | set to ‘00’ |
| Modulation and coding scheme | set to all ‘1’s |
| Resource block assignment | set to all ‘1’s |

In case that the UE receives a PDSCH without receiving a PDCCH or receives a PDCCH indicating SPS PDSCH release, the UE generates an HARQ-ACK information bit corresponding thereto. In addition, at least in Rel-15 NR, the UE does not expect to transmit HARQ-ACK information(s) for reception of two or more SPS PDSCHs to one PUCCH resource. In other words, at least in Rel-15 NR, the UE includes only HARQ-ACK information for one SPS PDSCH reception in one PUCCH resource.

The DL SPS may also be configured in a primary (P) cell and a secondary (S) cell. Parameters that can be configured for DL SPS higher layer signaling are as follows.
Periodicity: transmission period of DL SPS
nrofiARQ-processes: number of HARQ processes that can be configured for DL SPS
n1PUCCH-AN: PUCCH HARQ resource for DL SPS, a base station configures resource as PUCCH format 0 or 1.

The above-mentioned Table 29 to Table 30 will be possible fields in a situation in which only one DL SPS can be configured for each cell and for each BWP. In a situation in which a plurality of DL SPSs are configured for each cell and for each BWP, a DCI field for activating (or releasing) each DL SPS resource may differ. The disclosure provides a method for solving such a situation.

In the disclosure, not all DCI formats described in Table 29 and Table 30 are used to activate or release the DL SPS resource, respectively. For example, DCI format 1_0 and DCI format 1_1 used to schedule the PDSCH are used for activating a DL SPS resource. For example, DCI format 1_0 used for scheduling the PDSCH may be used for releasing the DL SPS resource.

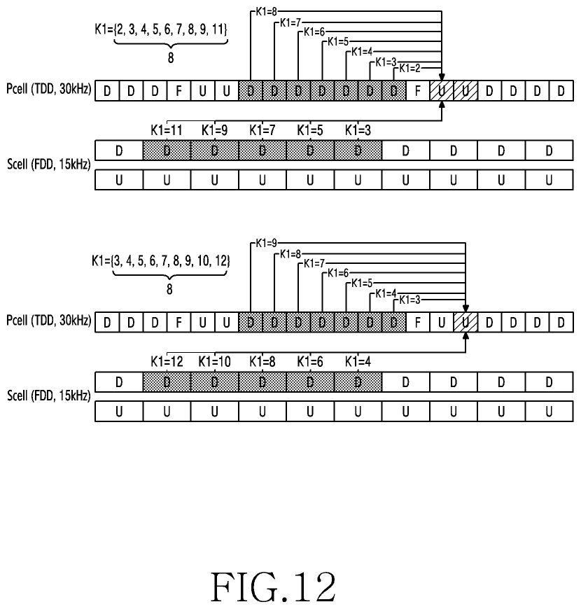

FIG. 12 illustrates a relationship of HARQ-ACK information transmission with respect to PDSCH reception in a CA situation according to an embodiment of the disclosure.

### Embodiment 1

A PDSCH-to-HARQ_feedback timing indicator field of DCI is used by a gNB to indicate a PUCCH slot for HARQ-ACK feedback transmission by referring to a PDSCH slot. In a case of DCI format 1_0, the PDSCH-to-HARQ_feedback timing indicator field may be mapped to a value of {1, 2, 3, 4, 5, 6, 7, 8}. In a case of DCI format 1_1, the PDSCH-to-HARQ_feedback timing indicator field may be mapped to a maximum of 8 values according to K1 (i.e., dl-DataToUL-ACK) configured as a value of 0 to 15.

In the environment of a TDD-FDD CA as shown in FIG. 12, one DL slot cannot be used for scheduling due to insufficient k1 values. In other words, when one UL slot is selected as the HARQ-ACK transmission resource in a PCell, at least nine k1 values are required because a PUCCH needs to be transmitted in the PCell, and consequently, one DL slot cannot be used from the perspective of PDSCH scheduling, thereby resulting a reduction in the downlink transmission rate with reference to a specific UE. Scheduling as shown in FIG. 12 cannot be supported with eight K1 values.

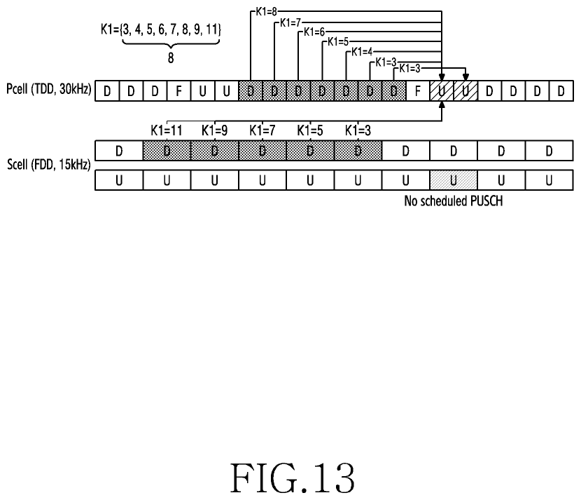

FIG. 13 illustrates a relationship of HARQ-ACK information transmission with respect to PDSCH reception in a CA situation according to an embodiment of the disclosure.

To solve the problem that scheduling as shown in FIG. 12 cannot be supported with eight K1 values, an alternative that can be considered is to use two consecutive UL slot(s) with eight values of k1, as shown in FIG. 13. However, PUSCH scheduling in a slot that overlaps with two consecutive UL slots in a SCell is not allowed due to the following scheduling constraints.

A UE does not expect to multiplex in a PUSCH transmission in one slot with SCS configuration μ₁ UCI of same type that the UE would transmit in PUCCHs in different slots with SCS configuration μ₂ if μ₁<μ₂.

Therefore, this alternative has issues related to PUSCH scheduling constraints. In summary, due to the maximum eight k1 values and the above scheduling constraints, the base station has a problem in which PUSCH scheduling constraints or PDSCH scheduling constraints occur in TDD-FDD CA scenarios.

To solve this problem, the following methods may be considered.
Method 1: Introduce a 4-bit PDSCH-to-HARQ_feedback timing indicator in DCI format 1_1
Method 2: Simultaneous PUCCH and PUSCH transmission

The following describes Method 1.

As previously described, in the existing CA environment, a method is provided for a UE to receive a PDSCH from a base station and transmit HARQ-ACK feedback thereto. Specifically, the base station may be able to indicate, via the DCI field, a difference between a slot in which the PDSCH is transmitted and a PUCCH slot containing HARQ-ACK feedback. The existing PDSCH-to-HARQ_feedback timing indicator field may provide a maximum of three bits of information. Thus, it is possible to indicate the difference (or offset) value between the maximum of eight PDSCH transmission slots and the PUCCH slot containing HARQ-ACK feedback. However, in a specific CA environment, it may be necessary to increase the PDSCH-to-HARQ_feedback timing indicator field for efficient resource utilization. Accordingly, the disclosure provides a method of supporting a PDSCH-to-HARQ_feedback timing indicator field of a maximum of 4 bits. Specifically, the disclosure provides a UE reporting method for supporting a PDSCH-to-HARQ_feedback timing indicator field of a maximum of 4 bits, a base station higher-layer signaling configuration related thereto, and a method for determining a PDSCH-to-HARQ_feedback timing indicator field by a UE and a base station based thereon are provided. The disclosure may enable the base station to perform scheduling for the UE in a more efficient use of resources in various CA environments.

This is called PDSCH-to-HARQ_feedback timing indicator field and may have a value of 0 bits to 4 bits. Support for the PDSCH-to-HARQ_feedback timing indicator field of 4 bits is limited to cases in which both the base station and the UE provide the corresponding function. For example, in case that at least one of the base station or UE does not support the PDSCH-to-HARQ_feedback timing indicator field of 4 bits, the base station configures the higher layer signal associated with the PDSCH-to-HARQ_feedback timing indicator field such that the number of bits in the PDSCH-to-HARQ_feedback timing indicator field determined by the higher layer signal has a value of at least one of 0 to 3. On the other hand, in case that neither the base station nor the UE supports the PDSCH-to-HARQ_feedback timing indicator field of 4 bits, the base station configures the higher layer signal associated with the PDSCH-to-HARQ_feedback timing indicator field such that the number of bits in the PDSCH-to-HARQ_feedback timing indicator field determined by the higher layer signal has a value of at least one of 0 to 4.

It may be possible to configure the higher layer signal associated with the PDSCH-to-HARQ_feedback timing indicator field according to each DCI format. Alternatively, the higher layer signal associated with the PDSCH-to-HARQ_feedback timing indicator field may be configured for each UE-common search space (CSS) or UE-specific search space (USS). Alternatively, the higher layer signal associated with the PDSCH-to-HARQ_feedback timing indicator field may be configured for each bandwidth part (BWP) or for each component carrier (CC). Alternatively, the higher layer signal associated with the PDSCH-to-HARQ_feedback timing indicator field may be configured together with the higher layer signaling associated with other DCI fields (e.g., HARQ process, PUCCH resource configuration, MCS information, SRS configuration information, CSI-RS-related information, NDI information, RV information, DAI information, and the like). While in the above, various methods in which a base station provides, to a UE, the higher layer signal associated with the PDSCH-to-HARQ_feedback timing indicator field have been described, the same may be applicable when a UE reports whether it supports the 4 bit PDSCH-to-HARQ_feedback timing indicator field. For example, when reporting whether the UE supports the 4 bit PDSCH-to-HARQ_feedback timing indicator field, it may be possible to report for each DCI format (or for each UE-common search space (CSS) or UE-specific search space (USS), for each bandwidth part (BWP), or for each component carrier (CC)).

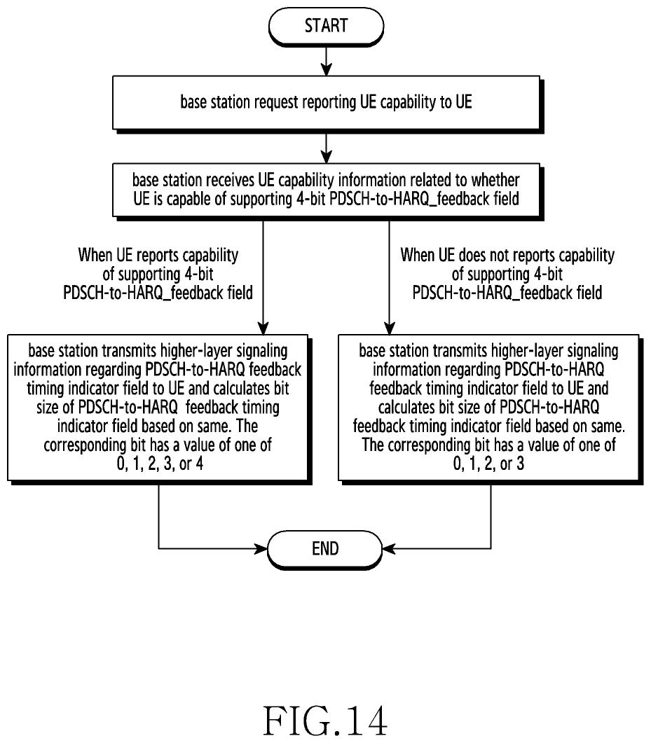

FIG. 14 illustrates a base station operation based on a UE capability of supporting 4-bit PDSCH-to-HARQ_feedback timing according to an embodiment of the disclosure.

Specifically, FIG. 14 is a flow diagram of a base station operation related to configuration and indication of a PDSCH-to-HARQ_feedback timing indicator field. The base station may receive UE capability reporting information from a UE to determine whether the UE supports 4 bits in association with the PDSCH-to-HARQ_feedback timing indicator field, and provide relevant configuration information to the UE accordingly.

Referring to FIG. 14, the base station may receive, from the UE, the UE capability information related to whether the UE is capable of supporting 4 bits in association with the PDSCH-to-HARQ_feedback timing indicator field. In this case, the base station may provide higher-layer signaling information in association with the PDSCH-to-HARQ_feedback timing indicator field to the UE that has reported the UE capability information. Further, the base station may calculate a bit size of the PDSCH-to-HARQ_feedback timing indicator field based on the UE capability information received from the UE. In an example, the corresponding bit value may have a value of one of 0, 1, 2, 3, or 4.

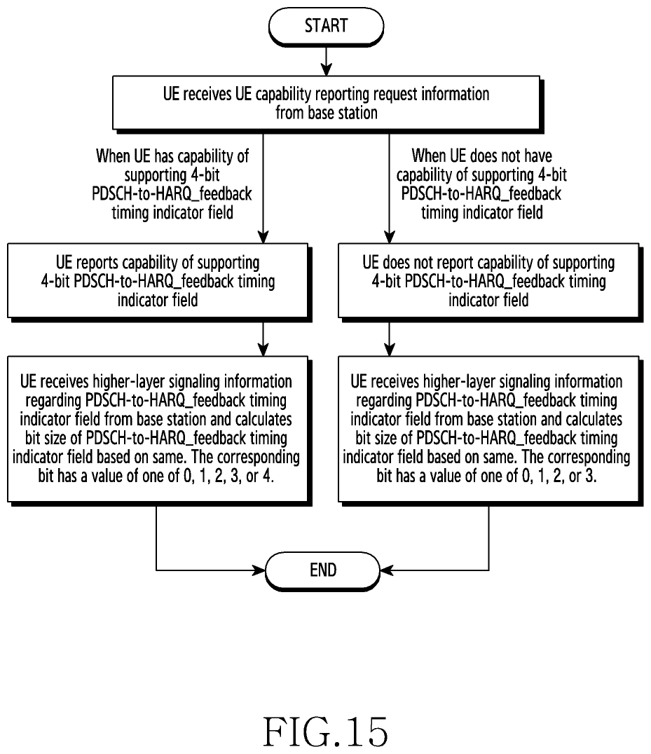

FIG. 15 is a flow diagram illustrating a UE operation based on the UE capability of supporting 4-bit PDSCH-to-HARQ_feedback timing according to an embodiment of the disclosure.

Specifically, FIG. 15 is a flow diagram of a UE operation related to configuration and indication of a PDSCH-to-HARQ_feedback timing indicator field. When receiving a request to report the UE capability related to the PDSCH-to-HARQ_feedback timing indicator field from the base station, the UE reports information regarding the request. Thereafter, upon receiving the relevant higher-layer signaling configuration from the base station, the UE determines K1 timing according to the method configured by the base station and performs the operation. At least one of Table 31 to Table 34 below is considered as the 3GPP specification document for supporting the above operation, and based on the same, the UE and the base station perform the operation through UE capabilities and higher-layer signaling exchange.

TABLE 31
7.3.1.2.2 Format 1_1
DCI format 1_1 is used for the scheduling of PDSCH in one cell.
The following information is transmitted by means of the DCI format 1_1 with CRC
scrambled by C-RNTI or CS-RNTI or MCS-C-RNTI:
---------------------------- unchanged parts are omitted ----------------------------
- PDSCH-to-HARQ_feedback timing indicator - 0, 1, 2, 3 or [symbol] 4 bits as defined in
Clause 9.2.3 of [5, TS 38.213]. The bitwidth for this field is determined as ┌log₂(I)┐ bits,
where I is the number of entries in the higher layer parameter dl-DataToUL-ACK.
---------------------------- unchanged parts are omitted ----------------------------

TABLE 32
9.1.2 Type-1 HARQ-ACK codebook determination
----------------------------unchanged parts are omitted----------------------------
A UE reports HARQ-ACK information for a corresponding PDSCH reception or SPS
PDSCH release only in a HARQ-ACK codebook that the UE transmits in a slot
indicated by a value of a PDSCH-to-HARQ_feedback timing indicator field in a
corresponding DCI format or provided by dl-DataToUL-ACK or dl-DataToUL-AC
K-r16 or dl-DataToUL-ACK-r16-ext4 or dl-DataToUL-ACK-DCI-1-2 if the
PDSCH-to-HARQ_feedback timing indicator field is not present in the DCI format
as described in clause 9.2.3. The UE reports NACK value(s) for HARQ-ACK information
bit(s) in a HARQ-ACK codebook that the UE transmits in a slot not indicated by a
value of a PDSCH-to-HARQ_feedback timing indicator field in a corresponding DCI
format.
-----------------------------unchanged parts are omitted-----------------------------
only in a HARQ-ACK codebook that the UE includes in a PUCCH or PUSCH
transmission in slot n + k, where n is the last UL slot overlapping with DL slot n_{D}
and k is a number of slots indicated by the PDSCH-to-HARQ_feedback timing
indicator field in a corresponding DCI format or provided by dl-DataToUL-ACK or
dl-DataToUL-ACK-r16 or dl-DataToUL-ACK-r16-ext4 or dl-DataToUL-ACK-DCI-
1-2 if the PDSCH-to-HARQ feedback timing indicator field is not present in the D
CI format. If the UE reports HARQ-ACK information for the PDSCH reception in a
slot other than slot n + k, the UE sets a value for each corresponding HARQ-ACK
information bit to NACK.
----------------------------unchanged parts are omitted----------------------------
9.1.2.1 Type-1 HARQ-ACK codebook in physical uplink control channel
----------------------------unchanged parts are omitted----------------------------
a) on a set of slot timing values K₁ associated with the active UL BWP
a) If the UE is configured to monitor PDCCH for DCI format 1_0 and is not
configured to monitor PDCCH for either DCI format 1_1 or DCI format 1_2 on serving
cell c, or the active DL BWP for serving cell c is dormant BWP, K₁ is provided by the
slot timing values {1, 2, 3, 4, 5, 6, 7, 8}
b) If the UE is configured to monitor PDCCH for DCI format 1_1
and is not configured to monitor PDCCH for DCI format 1_2 for serving cell c, K₁
is provided by dl-DataToUL-ACK or dl-DataToUL-ACK-r16 or dl-DataToUL-ACK-
r16-ext4
c) If the UE is configured to monitor PDCCH for DCI format 1_2 and is not
configured to monitor PDCCH for DCI format 1_1 for serving cell c, K₁ is provided
by dl-DataToUL-ACK-DCI-1-2
d) If the UE is configured to monitor PDCCH for DCI format 1_1 and DCI format
1_2 for serving cell c, K₁ is provided by the union of dl-DataToUL-ACK or dl-
DataToUL-ACK-r16 or dl-DataToUL-ACK-r16-ext4 and dl-DataToUL-ACK-DCI-
1-2
e) If an inapplicable value in dl-DataToUL-ACK-r16 is provided, the value is excluded from K₁
----------------------------unchanged parts are omitted----------------------------
If a UE is provided dl-DataToUL-ACK, dl-DataToUL-ACK-r16 or dl-DataToUL-
ACK-r16-ext4 or dl-DataToUL-ACK-DCI-1-2, the UE does not expect to be indicated
by DCI format 1_0 a slot timing value for transmission of HARQ-ACK information
that does not belong to the intersection of the set of slot timing values {1, 2, 3, 4,
5, 6, 7, 8} and the set of slot timing values provided by K₁ for the active DL BWP of
a corresponding serving cell.
----------------------------unchanged parts are omitted----------------------------
9.1.2.2 Type-1 HARQ-ACK codebook in physical uplink shared channel
If a UE would multiplex HARQ-ACK information in a PUSCH transmission that is
not scheduled by a DCI format or is scheduled by a DCI format that does not include
a DAI field, then
- if the UE has not received any PDSCH or SPS PDSCH release that the UE transmits
corresponding HARQ-ACK information in the PUSCH, based on a value of a
respective PDSCH-to-HARQ_feedback timing indicator field in a DCI format
scheduling the PDSCH reception or the SPS PDSCH release or on the value of dl-
DataToUL-ACK or dl-DataToUL-ACK-r16 or dl-DataToUL-ACK-r16-ext4 if the
PDSCH-to-HARQ_feedback timing indicator field is not present in DCI format 1_1
or on the value of dl-DataToUL-ACK-DCI-1-2 if the PDSCH-to-HARQ_feedback
timing indicator field is not present in DCI format 1_2, in any of the M_{c} occasions for
candidate PDSCH receptions by a DCI format or SPS PDSCH on any serving cell c,
as described in clause 9.1.2.1, the UE does not multiplex HARQ-ACK information
in the PUSCH transmission
----------------------------unchanged parts are omitted----------------------------
9.1.3.1 Type-2 HARQ-ACK codebook in physical uplink control channel
A UE determines monitoring occasions for PDCCH with DCI format scheduling
PDSCH receptions or SPS PDSCH release or indicating SCell dormancy on an active
DL BWP of a serving cell c, as described in clause 10.1, and for which the UE
transmits HARQ-ACK information in a same PUCCH in slot n based on
- PDSCH-to-HARQ_feedback timing indicator field values or a dl-DataToUL-
ACK, or dl-DataToUL-ACK-r16, or dl-DataToUL-ACK-r16-ext4, or dl-DataToUL-
ACK-DCI-1-2 value if the PDSCH-to-HARQ_feedback timing indicator field is not
present in a DCI format, for PUCCH transmission with HARQ-ACK information in
slot n in response to PDSCH receptions, SPS PDSCH release or SCell dormancy
indication
- slot offsets K₀ [6, TS 38.214] provided by time domain resource assignment
field in a DCI format scheduling PDSCH receptions and by PDSCH-
AggregationFactor, or pdsch-AggregationFactor-r16, or repetitionNumber, when
provided.
----------------------------unchanged parts are omitted----------------------------
9.1.3.3 Type-2 HARQ-ACK codebook grouping and HARQ-ACK retransmission
----------------------------unchanged parts are omitted----------------------------
Set i(g) to denote a PUCCH transmission occasion for multiplexing HARQ-ACK
information
Set k to the value of a PDSCH-to-HARQ_feedback timing field, if any,
in a DCI format providing a value of g
- If the DCI format does not include a PDSCH-to-HARQ_feedback timing field,
set k to the value provided by dl-DataToUL-ACK or dl-DataToUL-ACK-r16 or dl-
DataToUL-ACK-r16-ext4,
Set h(g) to the value of a first New feedback indicator field in the last DCI format
providing the value of g
----------------------------unchanged parts are omitted----------------------------
9.2.3 UE procedure for reporting HARQ-ACK
A UE does not expect to transmit more than one PUCCH with HARQ-ACK
information in a slot per priority index, if the UE is not provided
ackNackFeedbackMode = separate.
For DCI format 1_0, the PDSCH-to-HARQ_feedback timing indicator field values
map to {1, 2, 3, 4, 5, 6, 7, 8}. For a DCI format, other than DCI format 1_0 or
requesting Type-3 HARQ-ACK codebook report without scheduling a PDSCH
reception as described in clause 9.1.4, the PDSCH-to-HARQ_feedback timing
indicator field values, if present, map to values for a set of number of slots provided
by dl-DataToUL-ACK, dl-DataToUL-ACK-r16, or dl-DataToUL-ACK-r16-ext4, or
dl-DataToUL-ACK-DCI-1-2, as defined in Table 9.2.3-1.
----------------------------unchanged parts are omitted----------------------------
If the UE detects a DCI format that does not include a PDSCH-to-HARQ_feedback
timing indicator field and schedules a PDSCH reception or activates a SPS PDSCH
reception ending in DL slot n_{D}, the UE provides corresponding HARQ-ACK
information in a PUCCH transmission within UL slot n + k where k is provided by
dl-DataToUL-ACK, or dl-DataToUL-ACK-r16, or dl-DataToUL-ACK-r16-ext4, or
dl-DataToUL-ACK-DCI-1-2.
If the UE detects a DCI format scheduling a PDSCH reception ending in DL slot n_{D}
or if the UE detects a DCI format indicating a SPS PDSCH release or indicating SCell
dormancy through a PDCCH reception ending in DL slot n_{D}, or if the UE detects a
DCI format that requests Type-3 HARQ-ACK codebook report and does not schedule
a PDSCH reception through a PDCCH reception ending in DL slot n_{D}, as described
in clause 9.1.4, the UE provides corresponding HARQ-ACK information in a
PUCCH transmission within UL slot n + k, where k is a number of slots and is
indicated by the PDSCH-to-HARQ feedback timing indicator field in the DCI
format, if present, or provided by dl-DataToUL-ACK, dl-DataToUL-ACK-r16, or dl-
DataToUL-ACK-r16-ext4, or dl-DataToUL-ACK-DCI-1-2.
----------------------------unchanged parts are omitted----------------------------
Table 9.2.3-1: Mapping of PDSCH-to-HARQ_feedback timing indicator field values
to numbers of slots
PDSCH-to-HARQ feedback timing indicator

| 1 bit | 2 bits | 3 bits | 4 bits | Number of slots k |
|---|---|---|---|---|
| ‘0’ | ‘00’ | ‘000’ | ‘0000’ | 1^{st} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| ‘1’ | ‘01’ | ‘001’ | ‘0001’ | 2^{nd} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | ‘10’ | ‘010’ | ‘0010’ | 3^{rd} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | ‘11’ | ‘011’ | ‘0011’ | 4^{th} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | | ‘100’ | ‘0100’ | 5^{th} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | | ‘101’ | ‘0101’ | 6^{th} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | | ‘110’ | ‘0110’ | 7^{th} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | | ‘111’ | ‘0111’ | 8^{th} value provided by dl-DataToUL-ACK, |
| | | | | dl-DataToUL-ACK-r16, dl-DataToUL- |
| | | | | ACK-r16-ext4, or dl-DataToUL-ACK- |
| | | | | DCI-1-2 |
| | | | ‘1000’ | 9^{th} value provided by dl-DataToUL-ACK- |
| | | | | r16-ext4 |
| | | | ‘1001’ | 10^{th} value provided by dl-DataToUL-ACK- |
| | | | | r16-ext4 |
| | | | ‘1010’ | 11^{th} value provided by dl-DataToUL-ACK- |
| | | | | r16-ext4 |
| | | | ‘1011’ | 12^{th} value provided by dl-DataToUL-ACK- |
| | | | | r16-ext4 |
| | | | ‘1100’ | 13^{th} value provided by dl-DataToUL-ACK- |
| | | | | r16-ext4 |
| | | | ‘1101’ | 14^{th} value provided by dl-DataToUL-ACK- |
| | | | | r16-ext4 |
| | | | ‘1110’ | 15^{th} value provided by dl-DataToUL-ACK- |
| | | | | r16-ext4 |
| | | | ‘1111’ | 16^{th} value provided by dl-DataToUL-ACK- |
| | | | | r16-ext4 |

For a PUCCH transmission with HARQ-ACK information, a UE determines a
PUCCH resource after determining a set of PUCCH resources for O_{UCI} HARQ-ACK
information bits, as described in clause 9.2.1. The PUCCH resource deterination is
based on a PUCCH resource indicator field [5, TS 38.212], if present, in a last DCI
format, excluding the SPS activation DCI, among the DCI formats that have a value
of a PDSCH-to-HARQ_feedback timing indicator field, if present, or a value of dl-
DataToUL-ACK, or dl-DataToUL-ACK-r16, or dl-DataToUL-ACK-r16-ext4, or dl-
DataToUL-ACK-DCI-1-2, indicating a same slot for the PUCCH transmission, that
the UE detects and for which the UE transmits corresponding HARQ-ACK
information in the PUCCH where, for PUCCH resource determination, detected DCI
formats are first indexed in an ascending order across serving cells indexes for a same
PDCCH monitoring occasion and are then indexed in an ascending order across
PDCCH monitoring occasionindexes. For indexing DCI formats within a serving cell
for a same PDCCH monitoring occasion, if the UE is not provided coresetPoolIndex
or is provided coresetPoolIndex with value 0 for one or more first CORESETs and is
provided coresetPoolIndex with value 1 for one or more second CORESETs on an
active DL BWP of a serving cell, and with ackNackFeedbackMode = joint for the
active UL BWP, detected DCI formats from PDCCH receptions in the first
CORESETs are indexed prior to detected DCI formats from PDCCH receptions in
the second CORESETs.
----------------------------unchanged parts are omitted----------------------------
For the first set of PUCCH resources and when the size R_{PUCCH} of resourceList is larger
than eight, when a UE provides HARQ-ACK information in a PUCCH transmission
in response to detecting a last DCI format in a PDCCH reception, among DCI formats
with a value of the PDSCH-to-HARQ feedback timing indicator field, if present, or
a value of dl-DataToUL-ACK, or dl-DataToUL-ACK-r16, or dl-DataToUL-ACK-
r16-ext4, or dl-DataToUL-ACK-DCI-1-2, indicating a same slot for the PUCCH
transmission, the UE determines a PUCCH resource with index r_{PUCCH},
0 ≤ r_{PUCCH} ≤ R_{PPUCH} − 1, as
${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ ⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + {R}_{PUCCH} mod 8 & if {Δ}_{PRI} \geq {R}_{PUCCH} mod 8\end{matrix} \}$
where N_{CCE,p} is a number of CCEs in CORESET p of the PDCCH reception for
the DCI format as described in clause 10.1, n_{CCE,p} is the index of a first CCE for the
PDCCH reception, and Δ_{PRI} is a value of the PUCCH resource indicator field in the
DCI format. If the DCI format does not include a PUCCH resource indicator field,
Δ_{PRI} = 0.
----------------------------unchanged parts are omitted----------------------------
9.2.5.2UE procedure for multiplexing HARQ-ACK/SR/CSI in a PUCCH
----------------------------unchanged parts are omitted----------------------------
If a UE has HARQ-ACK, SR and wideband or sub-band CSI reports to transmit and
the UE determines a PUCCH resource with PUCCH format 2, or the UE has HARQ-
ACK, SR and wideband CSI reports [6, TS 38.214] to transmit and the UE determines
a PUCCH resource with PUCCH format 3 or PUCCH format 4, where
the UE determines the PUCCH resource using the PUCCH resource indicator field
[5, TS 38.212] in a last of a number of DCI formats with a value of a PDSCH-to-
HARQ_ feedback timing indicator field, if present, or a value of dl-DataToUL-ACK,
or dl-DataToUL-ACK-r16, or dl-DataToUL-ACK-DCI-1-2, indicating a same slot
for the PUCCH transmission, or by a value provided by dl-DataToUL-ACK or dl-D
ataToUL-ACK-r16 or dl-DataToUL-ACK-r16-ext4 or dl-DataToUL-ACK-DCI-1-2
if the PDSCH-to-HARQ_feedback timing indicator field is not present in the last
DCI format, from a PUCCH resource set provided to the UE for HARQ-ACK
transmission, and
----------------------------unchanged parts are omitted----------------------------
If a UE is provided
a first interlace of M_{Interlace,0}^{PUCCH} PRBs by interlace0 in InterlaceAllocation, the UE has
HARQ-ACK, SR and wideband or sub-band CSI reports to transmit, and the UE
determines a PUCCH resource with PUCCH format 2, or the UE has HARQ-ACK, SR
and wideband CSI reports to transmit and the UE determines a PUCCH resource with
PUCCH format 3, where
- the UE determines the PUCCH resource using the PUCCH resource indicator
field in a last of a number of DCI formats with a value of a PDSCH-to-
HARQ_feedback timing indicator field indicating a same slot for the PUCCH
transmission, or a value provided by dl-DataToUL-ACK or dl-DataToUL-ACK-r16
or dl-DataToUL-ACK-r16-ext4 or dl-DataToUL-ACK-DCI-1-2 if the PDSCH-to-HARQ_
feedback timing indicator field is not present in a DCI format, from a PUCCH
resource set provided to the UE for HARQ-ACK transmission, and
----------------------------unchanged parts are omitted----------------------------
If a UE is provided
a first interlace of M_{Interlace,0}^{PUCCH} PRBs by interlace0 in InterlaceAllocation, the UE has
HARQ-ACK, SR and sub-band CSI reports to transmit, and the UE determines a
PUCCH resource with PUCCH format 3, where
- the UE determines the PUCCH resource using the PUCCH resource indicator
field in a last of a number of DCI formats that have a value of a PDSCH-to-
HARQ_feedback timing indicator field indicating a same slot for the PUCCH transmission,
or a value provided by dl-DataToUL-ACK or dl-DataToUL-ACK-r16 or dl-
DataToUL-ACK-r16-ext4 or dl-DataToUL-ACK-DCI-1-2 if the PDSCH-to-HARQ_
feedback timing indicator field is not present in the last DCI format, from a PUCCH
resource set provided to the UE for HARQ-ACK transmission, and
----------------------------unchanged parts are omitted----------------------------

TABLE 33

| | | | | | | Applicable to |
|---|---|---|---|---|---|---|
| | | | | | | the capability |
| | | | | | Need for | signalling |
| | | | | | the gNB to | exchange |
| | | | | Prerequisite | know if the | between UEs |
| | | | | feature | feature is | (V2XWI |
| Features | Index | Feature group | Components | groups | supported | only)”. |
| | FG- | Extension of | Indicate whether | | Yes | N/A |
| | xyz | PDSCH-to- | the UE supports | | | |
| | | HARQ_feedback | 4-bit PDSCH-to- | | | |
| | | timing field | HARQ_feedback | | | |
| | | | timing field | | | |

| | | | | Capability | | |
|---|---|---|---|---|---|---|
| | | | | interpretation | | |
| Consequence if | | | | for mixture | | |
| the feature is | | Need of | Need of | of FDD/TDD | | |
| not supported | | FDD/TDD | FR1/FR2 | and/or | | Mandatory/ |
| by the UE | Type | differentiation | differentiation | FR1/FR2 | Note | Optional |
| | Per | No | No | | | Optional |
| | BC | | | | | with |
| | | | | | | capability |
| | | | | | | signalling |

TABLE 34
PUCCH-Config ::= SEQUENCE {
---------------------------- unchanged parts are omitted ----------------------------
dl-DataToUL-ACK-r16-ext4 SetupRelease { DL-DataToUL-ACK-r16-ext4 }
OPTIONAL, -- Need M
}
---------------------------- unchanged parts are omitted ----------------------------
DL-DataToUL-ACK-r16-ext4 ::= SEQUENCE (SIZE (1..16)) OF INTEGER (0..15)
-- TAG-PUCCH-CONFIG-STOP
-- ASN1STOP
dl-DataToUL-ACK, dl-DataToUL-ACK-DCI-1-2
List of timing for given PDSCH to the DL ACK (see TS 38.213 [13], clause 9.1.2).
The field dl-DataToUL-ACK applies to DCI format 1_1 and the field dl-DataToUL-
ACK-DCI-1-2 applies to DCI format 1_2 (see TS 38.212 [17], clause 7.3.1 and TS
38.213 [13], clause 9.2.3). If dl-DataToUL-ACK-r16 is signaled, UE shall ignore the
dl-DataToUL-ACK or dl-DataToUL-ACK-r16-ext4 (without suffix). The value −1
corresponds to “inapplicable value” for the case where the A/N feedback timing is
not explicitly included at the time of scheduling PDSCH. If dl-DataToUL-ACK-r16-
ext4 is signaled, UE shall ignore the dl-DataToUL-ACK or dl-DataToUL-ACK-r16
(without suffix).

The following describes Method 2.

As described with reference to FIG. 13, it is possible to use existing eight k1 values to select a PUCCH transmission slot in which the HARQ-ACK information is to be transmitted, but this causes the problem that PUSCH is unable to be scheduled in the SCell. To solve this problem, separate transmission of PUCCH and PUSCH may be considered. The fact that simultaneous transmission of PUCCH and PUSCH is possible is understood as meaning that the UCI of PUCCH is always transmitted through the PCell without the need of being multiplexed to the PUSCH in the SCell. Specifically, if the UCI containing the HARQ-ACK information in the PCell overlaps with another PUSCH in the PCell, the UE transmits the HARQ-ACK information via the corresponding PUSCH, otherwise the UE transmits the HARQ-ACK information via the PUCCH in the PCell. Separately, if a PUSCH is scheduled in the SCell, the UE transmits the PUSCH regardless of whether the corresponding PUSCH overlaps with the PUCCH in the PCell. The fact that simultaneous PUCCH and PUSCH transmission is not possible is understood as meaning that the UCI of the PUCCH can be transmitted to the SCell or the PCell, and a case in which the UCI of the PUCCH is transmitted to the SCell is possible when the PUSCH and PUCCH of the SCell overlap each other and there is no overlapping PUSCH in the PCell. In other words, when the UCI in the PUCCH overlaps with at least one PUSCH in the PCell or SCell, the UE transmits UCI information while including the same in the corresponding PUSCH, otherwise, the UE transmits the UCI via the PUCCH in the PCell. In this case, another condition in which simultaneous PUCCH and PUSCH transmission is possible may be limited to a case in which the PUCCH and the PUSCH have the same priority or limited to a case in which the priorities of the PUCCH and PUSCH are different. Alternatively, the PUSCH and PUCCH may be applied commonly regardless of the priorities. The priority information may be provided through at least one of the higher layer signal or L1 signal.

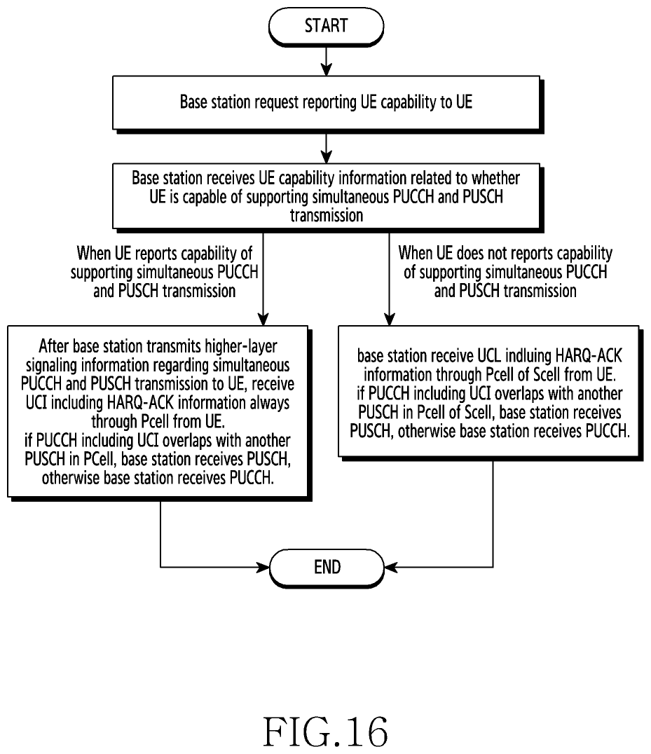

FIG. 16 is a flow diagram illustrating a base station operation based on a UE capability of supporting simultaneous PUCCH and PUSCH transmission according to an embodiment of the disclosure.

Specifically, FIG. 16 is a flow diagram of a base station operation related to a configuration and an indication with respect to simultaneous PUCCH and PUSCH support. The base station may receive UE capability reporting information from a UE to determine whether the UE supports the PUCCH and the PUSCH simultaneously, and provide relevant configuration information to the UE accordingly.

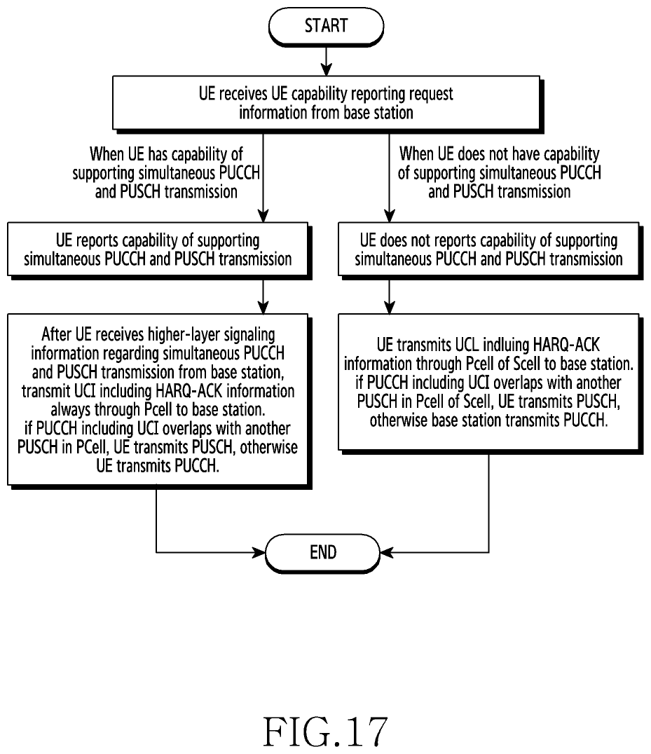

FIG. 17 is a flow diagram illustrating a UE operation based on UE capability of supporting simultaneous PUCCH and PUSCH transmission according to an embodiment of the disclosure.

When a UE receives, from a base station, a request to report the UE capability related to simultaneous PUCCH and PUSCH support, the UE reports information regarding the request. Thereafter, upon receiving the relevant higher-layer signaling configuration from the base station, the UE receives the base station scheduling information accordingly and performs an operation according to the methods described above. At least one of Table 35 to Table 38 below is considered as the 3GPP specification document for supporting the above operation, and based on the same, the UE and the base station perform the operation through UE capabilities and higher-layer signaling exchange.

TABLE 35

9 UE procedure for reporting control information
---------------------------- unchanged parts are omitted ----------------------------
A UE does not expect to multiplex in a PUSCH transmission in one slot
with SCS configuration μ₁ UCI of same type that the UE would transmit
in PUCCHs in different slots with SCS configuration μ₂ if μ₁ < μ₂. In this
case, if the UE can simultaneously transmit the PUCCHs and the PUSCH
[TS38.306] and is provided simultaneousPUCCH-PUSCH-new, the UE
transmits the PUCCHs and the PUSCH simultaneously.
---------------------------- unchanged parts are omitted ----------------------------

TABLE 36
9 UE procedure for reporting control information
---------------------------- unchanged parts are omitted ----------------------------
If a UE
- is provided simultaneousPUCCH-PUSCH-new, where PUCCH(s) and PUSCH(s)
overlap in time and PUCCH(s) and PUSCH(s) are in different serving cells
- can simultaneously transmit the PUCCH and the PUSCHs [18, TS 38.306],
the UE excludes the PUSCHs for resolving the time overlapping between the
PUCCH and PUSCHs, where the timeline conditions are not required for
the excluded PUSCHs.
---------------------------- unchanged parts are omitted ----------------------------

TABLE 37

PhysicalCellGroupConfig ::= SEQUENCE {
---------------------------- unchanged parts are omitted ----------------------------
simultaneousPUCCH-PUSCH-new-r17 ENUMERATED {enabled}
---------------------------- unchanged parts are omitted ----------------------------
}
simultaneousPUCCH-PUSCH-new-r17
Enables simultaneous PUCCH and PUSCH transmissions for the primary
PUCCH group and the secondary PUCCH group, respectively.

TABLE 38
parallelTxPUCCH-PUSCH-new-r17
Indicates whether the UE supports simultaneous PUCCH and PUSCH
transmissions on different cells (or inter-band CA).

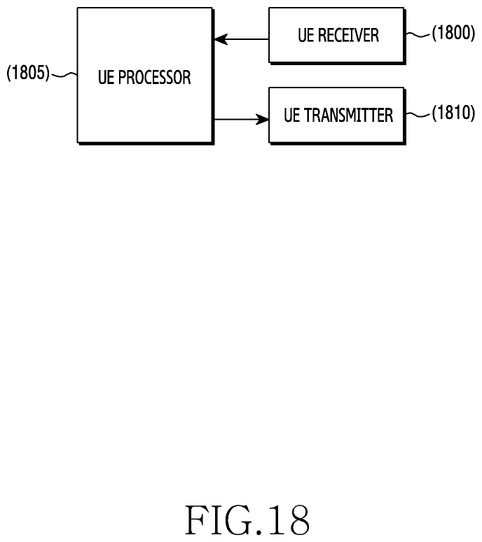

FIG. 18 illustrates a structure of a UE in a wireless communication system according to an embodiment of the disclosure.

Referring to FIG. 18, the UE may include a transceiver, which refers to a UE receiver 1800 and a UE transmitter 1810 as a whole, memory (not illustrated), and a UE processor 1805 (or UE controller or processor). The UE receiver 1800 and the UE transmitter 1810, the memory, and the UE processor 1805 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The UE receiver 1800 and the UE transmitter 1810 may transmit/receive signals with the base station. The signals may include control information and data. To this end, the transceiver may include a radio frequency (RF) transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the UE receiver 1800 and the UE transmitter 1810 may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media, such as read only memory (ROM), random access memory (RAM), hard disk, compact disc (CD)-ROM, and digital versatile disc (DVD), or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

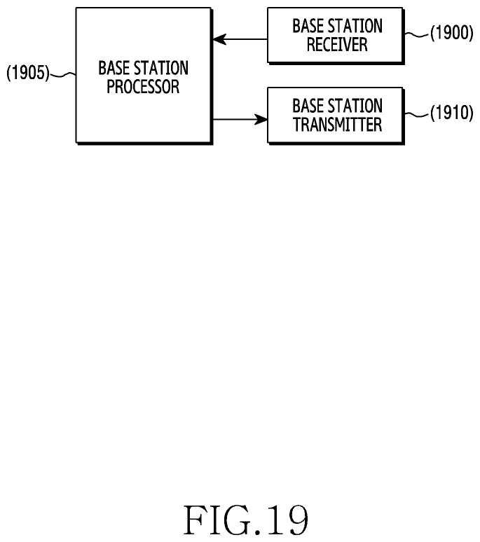

FIG. 19 illustrates a structure of a base station in a wireless communication system according to an embodiment of the disclosure.

Referring to FIG. 19, the base station may include a transceiver, which refers to a base station receiver 1900 and a base station transmitter 1910 as a whole, memory (not illustrated), and a base station processor 1905 (or base station controller or processor). The base station receiver 1900 and the base station transmitter 1910, the memory, and the base station processor 1905 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The base station receiver 1900 and the base station transmitter 1910 may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the base station receiver 1900 and the base station transmitter 1910, and the components of the transceiver are not limited to the RF transmitter and the RF receiver.

In addition, the base station receiver 1900 and the base station transmitter 1910 may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media, such as ROM, RAM, hard disk, CD-ROM, and DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

In addition, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. For example, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems, such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to a base station (BS), UE capability information for simultaneous transmission of a physical uplink shared channel (PUSCH) and a physical uplink control channel (PUCCH) of a same priority;
receiving, from the BS, configuration information for the simultaneous transmission; and
transmitting, to the BS, the PUSCH on a first cell and the PUCCH on a second cell based on the configuration information,
wherein the PUSCH is excluded from resolving of time overlapping between the PUCCH and the PUSCH based on the configuration information.

2. The method of claim 1, wherein a timeline condition is not required for the excluded PUSCH from resolving of the time overlapping between the PUCCH and the PUSCH.

3. The method of claim 1, wherein the first cell and the second cell are different from each other.

4. The method of claim 1,
wherein the PUCCH and the PUSCH are simultaneously transmitted to the BS for a primary PUCCH group, and
wherein, in case that a third cell and a fourth cell are associated with a secondary PUCCH group, a PUSCH of the third cell and a PUCCH of the fourth cell are simultaneously transmitted to the BS for the secondary PUCCH group.

5. A method performed by a base station (BS) in a wireless communication system, the method comprising:
receiving, from a user equipment (UE), UE capability information for simultaneous transmission of a physical uplink shared channel (PUSCH) and a physical uplink control channel (PUCCH) of a same priority;
transmitting, to the UE, configuration information for the simultaneous transmission; and
receiving, from the UE, the PUSCH on a first cell and the PUCCH on a second cell based on the configuration information,
wherein the PUSCH is excluded from resolving of time overlapping between the PUCCH and the PUSCH based on the configuration information.

6. The method of claim 5, wherein a timeline condition is not required for the excluded PUSCH from resolving of the time overlapping between the PUCCH and the PUSCH.

7. The method of claim 5, wherein the first cell and the second cell are different from each other.

8. The method of claim 5,
wherein the PUCCH and the PUSCH are simultaneously received from the UE for a primary PUCCH group, and
wherein, in case that a third cell and a fourth cell are associated with a secondary PUCCH group, a PUSCH of the third cell and a PUCCH of the fourth cell are simultaneously received from the US for the secondary PUCCH group.

9. A user equipment (UE) in a wireless communication system, the UE comprising:
a transceiver; and
a controller coupled with the transceiver and configured to:
transmit, to a base station (BS), UE capability information for simultaneous transmission of a physical uplink shared channel (PUSCH) and a physical uplink control channel (PUCCH) of a same priority,
receive, from the BS, configuration information for the simultaneous transmission, and
transmit, to the BS, the PUSCH on a first cell and the PUCCH on a second cell based on the configuration information,
wherein the PUSCH is excluded from resolving of time overlapping between the PUCCH and the PUSCH based on the configuration information.

10. The UE of claim 9, wherein a timeline condition is not required for the excluded PUSCH from resolving of the time overlapping between the PUCCH and the PUSCH.

11. The UE of claim 9, wherein the first cell and the second cell are different from each other.

12. The UE of claim 9,
wherein the PUCCH and the PUSCH are simultaneously transmitted to the BS for a primary PUCCH group, and
wherein, in case that a third cell and a fourth cell are associated with a secondary PUCCH group, a PUSCH of the third cell and a PUCCH of the fourth cell are simultaneously transmitted to the BS for the secondary PUCCH group.

13. A base station (BS) in a wireless communication system, the BS comprising:
a transceiver; and
a controller coupled with the transceiver and configured to:
receive, from a user equipment (UE), UE capability information for simultaneous transmission of a physical uplink shared channel (PUSCH) and a physical uplink control channel (PUCCH) of a same priority,
transmit, to the UE, configuration information for the simultaneous transmission, and
receive, from the UE, the PUSCH on a first cell and the PUCCH on a second cell based on the configuration information,
wherein the PUSCH is excluded from resolving of time overlapping between the PUCCH and the PUSCH based on the configuration information.

14. The BS of claim 13, wherein a timeline condition is not required for the excluded PUSCH from resolving of the time overlapping between the PUCCH and the PUSCH.

15. The BS of claim 13, wherein the first cell and the second cell are different from each other.

16. The BS of claim 13,
wherein the PUCCH and the PUSCH are simultaneously received from the UE for a primary PUCCH group, and
wherein, in case that a third cell and a fourth cell are associated with a secondary PUCCH group, a PUSCH of the third cell and a PUCCH of the fourth cell are simultaneously received from the US for the secondary PUCCH group.
